(19) United States
(12) Patent Application Publication
(10) Pub. No.: US 2012/0229429 A1
(43) Pub. Date: Sep. 13, 2012

(54) DISPLAY AND METHOD OF DRIVING THE SAME, AS WELL AS BARRIER DEVICE AND METHOD OF PRODUCING THE SAME

(75) Inventor: Yuichi Inoue, Kanagawa (JP)

(73) Assignee: Sony Corporation, Tokyo (JP)

(21) Appl. No.: 13/403,027

(22) Filed: Feb. 23, 2012

(30) Foreign Application Priority Data
Mar. 7, 2011 (JP) 2011-049524

(51) Int. Cl. G06F 3/038; G02F 1/13357; G09G 3/36; G02F 1/1333

(52) U.S. Cl. 345/204; 349/110; 349/62; 345/87

(57) ABSTRACT

A display includes: a display section displaying an image; and a liquid-crystal barrier section having a plurality of liquid crystal barriers each allowed to switch between a light-transmitting state and a light-blocking state. The liquid-crystal barrier section includes a liquid crystal layer, and a first substrate and a second substrate configured to sandwich the liquid crystal layer, the second substrate having a common electrode formed on a first-substrate side thereof, and the first substrate including a first electrode formed at a position corresponding to each of the liquid crystal barriers, and a second electrode formed, between the first electrode and the liquid crystal layer, at the position corresponding to each of the liquid crystal barriers.

### BACKGROUND

The present disclosure relates to a display with a parallax barrier system in which stereoscopic vision display is possible and a method of driving the display, and also to a barrier device used in such a display and a method of producing the barrier device.

In recent years, displays which may realize stereoscopic vision display have been attracting attention. In the stereoscopic vision display, a left-eye image and a right-eye image having parallax with respect to each other (having different eye points) are displayed, and a viewer may recognize the images as a stereoscopic image with a depth by watching the images with the right and left eyes. Further, there has been developed a display that may provide a more natural stereoscopic image to a viewer, by displaying three or more images having parallax with respect to one another.

Such displays are roughly divided into those with dedicated glasses and those without dedicated glasses, and those without dedicated glasses are desired because viewers find it inconvenient to wear the dedicated glasses. The displays without dedicated glasses include, for example, those employing a lenticular lens system, and those employing a parallax barrier system. In these systems, a plurality of images having parallax with respect to each other (perspective images) is simultaneously displayed, and a viewable image is varied depending on the relative positional relation (an angle) between a display and the eye point of a viewer. For example, Japanese Unexamined Patent Application Publication No. H03-119889 discloses a display employing a parallax barrier system and using a liquid crystal element as a barrier.

Incidentally, in a liquid crystal display (LCD), for example, a liquid crystal in a VA (Vertical Alignment) mode is often used. In such a liquid crystal display, a liquid crystal molecule at the time when no voltage is applied (in an OFF state) is aligned along a direction in which the major axis is perpendicular to a substrate surface, but at the time when a voltage is applied (in an ON state), the liquid crystal molecule is aligned to fall (tilt) according to the magnitude of the voltage. Therefore, when a voltage is applied to a liquid crystal layer in the state in which no voltage is applied and thereby the liquid crystal molecule that has been aligned perpendicularly to the substrate surface falls, there is a possibility that disturbance in the alignment of the liquid crystal molecule may occur, because the direction in which the liquid crystal molecule falls is arbitrary. In this case, in such a liquid crystal display, a response to the voltage is slow.

Thus, a technique of aligning a liquid crystal molecule by tilting the liquid crystal molecule beforehand (giving a so-called pretilt) in a specific direction is used to control the direction in which the liquid crystal molecule falls at the time of a voltage response. For example, Japanese Unexamined Patent Application Publication No. 2002-107730 has proposed a PSA (Polymer Sustained Alignment) mode in which a plurality of slits are provided in a pixel electrode, a counter electrode is formed solidly (without slit), and liquid crystal molecules are maintained in a pretilt state by a polymer. According to such a technique using the pretilt, voltage response characteristics of a liquid crystal molecule may be improved.

### SUMMARY

Incidentally, in a case where a barrier is configured using a liquid crystal element in a display employing the parallax barrier system, making an improvement in response characteristics of the barrier is also expected. However, no specific method therefore has been suggested yet.

In view of the foregoing, it is desirable to provide a display and a method of driving the display, as well as a barrier device and a method of producing the barrier device, in which response characteristics of a liquid crystal barrier may be improved.

According to an embodiment of the present disclosure, there is provided a display including a display section and a liquid-crystal barrier section. The display section displays an image. The liquid-crystal barrier section has a plurality of liquid crystal barriers each allowed to switch between a light-transmitting state and a light-blocking state. The liquid-crystal barrier section includes: a liquid crystal layer; and a first substrate and a second substrate configured to sandwich the liquid crystal layer. The second substrate has a common electrode formed on a first-substrate side thereof. The first substrate includes: a first electrode formed at a position corresponding to each of the liquid crystal barriers; and a second electrode formed, between the first electrode and the liquid crystal layer, at the position corresponding to each of the liquid crystal barriers.

According to another embodiment of the present disclosure, there is provided a display including a display section and a liquid-crystal barrier section including a plurality of liquid crystal barriers. The liquid-crystal barrier section includes a liquid crystal layer including liquid crystal molecules maintained in a state of being inclined from a vertical direction, and a first substrate and a second substrate that are configured to sandwich the liquid crystal layer. The second substrate has a common electrode formed on a side facing the first substrate. The first substrate includes a first electrode formed at a position corresponding to each of the liquid crystal barriers, and a second electrode formed between the first electrode and the liquid crystal layer, at the position corresponding to each of the liquid crystal barriers.

According to another embodiment of the present disclosure, there is provided a display including a display section and a barrier section. The barrier section includes liquid crystal molecules maintained in a state of being inclined from a vertical direction.

According to another embodiment of the present disclosure, a method of driving a display is provided. The method includes: driving a plurality of liquid crystal barriers each allowed to switch between a light-transmitting state and a light-blocking state; and displaying an image in synchronization with driving of the liquid crystal barriers. The driving of the liquid crystal barrier includes applying a drive signal to a first electrode or both the first electrode and a second electrode. The first electrode is formed at a position corresponding to each of the liquid crystal barriers, and the second electrode is formed at the position corresponding to each of the liquid crystal barriers, in a layer different from the first electrode. The driving of the liquid crystal barrier further includes: applying a common signal to a common electrode. The common electrode is disposed on an opposite side of the second electrode from the first electrode and is opposed to and apart from the second electrode with the liquid crystal layer in between.

According to another embodiment of the present disclosure, there is provided a barrier device including: a liquid crystal layer; and a first substrate and a second substrate configured to sandwich the liquid crystal layer. The second substrate has a common electrode formed on a first-substrate side thereof. The first substrate includes a plurality of first electrodes, and second electrodes each formed between the first electrode and the liquid crystal layer, at the position corresponding to each of the first electrodes.

According to another embodiment of the present disclosure, a method of producing a barrier device is provided. The method includes: forming a plurality of first electrodes on a first substrate, and forming a second electrode over and apart from each of the first electrodes, at a position corresponding to each of the first electrodes; and forming a common electrode on a second substrate. The method further includes: sealing a liquid crystal layer between a surface of the first substrate and the second substrate, the surface being on a side where the first and second electrodes are formed; and providing a pretilt to the liquid crystal layer, by exposing the liquid crystal layer, while applying a voltage to the liquid crystal layer through at least the second electrode and the common electrode.

In the display and the method of driving the same, as well as the barrier device and the method of producing the same according to the embodiments of the present disclosure, the liquid crystal barriers of the liquid-crystal barrier section enter the light-transmitting state, and thereby an image displayed on the display section is visually recognized by a viewer. At the time, the liquid crystal molecules of the liquid crystal layer are controlled based on the voltages of the first electrode, the second electrode, and the common electrode.

According to the display and the method of driving the same, as well as the barrier device and the method of producing the same in the embodiments described above, the first electrode and the second electrode are provided on the first substrate and thus, it is possible to improve response characteristics of the liquid crystal barrier.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a configurational example of a stereoscopic display according to an embodiment of the present disclosure.

FIGS. 2A and 2B are explanatory drawings illustrating a configurational example of the stereoscopic display illustrated in FIG. 1.

FIG. 3 is a block diagram illustrating a configurational example of a display drive section and a display section illustrated in FIG. 1.

FIGS. 4A and 4B are explanatory drawings illustrating a configurational example of the display section illustrated in FIG. 1.

FIGS. 5A and 5B are explanatory drawings illustrating a configurational example of a liquid-crystal barrier section illustrated in FIG. 1.

FIGS. 6A and 6B are explanatory drawings illustrating a configurational example of a transparent electrode layer according to the liquid-crystal barrier section illustrated in FIG. 1.

FIG. 7 is a schematic diagram illustrating alignment of a liquid crystal molecule according to the liquid-crystal barrier section illustrated in FIG. 1.

FIG. 8 is a waveform chart illustrating an example of a drive signal of a barrier drive section illustrated in FIG. 1.

FIG. 9 is an explanatory drawing illustrating an example of a group configuration of the liquid-crystal barrier section illustrated in FIG. 1.

FIGS. 10A to 10C are schematic diagrams illustrating an example of operation of the display section and the liquid-crystal barrier section illustrated in FIG. 1.

FIGS. 11A and 11B are other schematic diagrams illustrating an example of the operation of the display section and the liquid-crystal barrier section illustrated in FIG. 1.

FIG. 12 is a timing chart illustrating an example of operation of the stereoscopic display illustrated in FIG. 1.

FIGS. 13A to 13E are characteristic diagrams each illustrating an equipotential distribution in a liquid crystal layer according to the liquid-crystal barrier section illustrated in FIG. 1.

FIG. 14 is a schematic diagram illustrating alignment of liquid crystal molecules in the liquid crystal layer according to the liquid-crystal barrier section illustrated in FIG. 1.

FIG. 15 is a characteristic diagram illustrating transmittance of the liquid-crystal barrier section illustrated in FIG. 1.

FIG. 16 is a flowchart illustrating a production process of the liquid-crystal barrier section illustrated in FIG. 1.

FIGS. 17A and 17B are explanatory drawings illustrating a pretilt providing step of the liquid-crystal barrier section illustrated in FIG. 1.

FIG. 18 is a cross-sectional diagram illustrating a configurational example of a liquid-crystal barrier section according to a comparative example of the embodiment.

FIG. 19 is a schematic diagram illustrating alignment of liquid crystal molecules in a liquid crystal layer of the liquid-crystal barrier section according to the comparative example of the embodiment.

FIG. 20 is an explanatory drawing illustrating a configurational example of a transparent electrode layer in a liquid-crystal barrier section according to a modification of the embodiment.

FIG. 21 is a cross-sectional diagram illustrating a configurational example of a transparent electrode layer in a liquid-crystal barrier section according to another modification of the embodiment.

FIGS. 22A and 22B are explanatory drawings illustrating a configurational example of a stereoscopic display according to a modification.

FIGS. 23A and 23B are schematic diagrams illustrating an example of operation of the stereoscopic display according to the modification.

FIGS. 24A and 24B are plan views illustrating a configurational example of a liquid-crystal barrier section according to another modification.

FIGS. 25A to 25C are schematic diagrams illustrating an example of operation of a display section and a liquid-crystal barrier section according to another modification.

### DETAILED DESCRIPTION OF EMBODIMENT

An embodiment of the present disclosure will be described below in detail with reference to the drawings.

### CONFIGURATION EXAMPLE

### OVERALL CONFIGURATION EXAMPLE

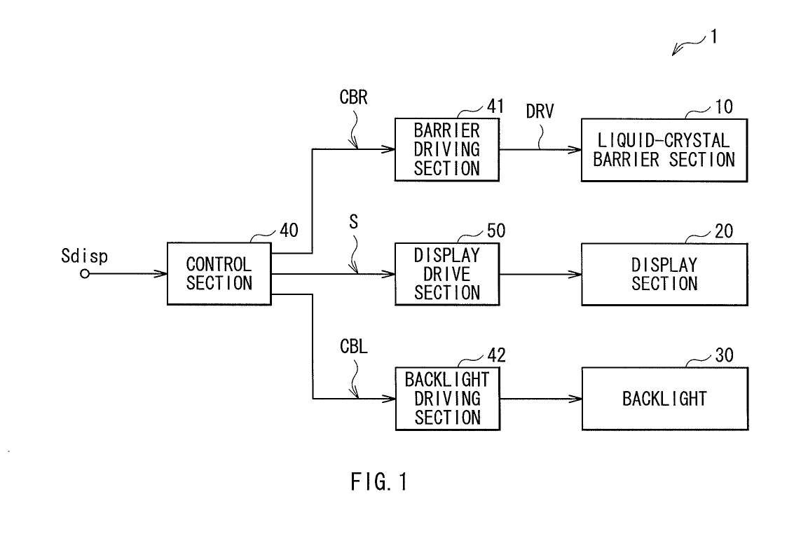

FIG. 1 illustrates a configurational example of a stereoscopic display 1 according to an embodiment. The stereoscopic display 1 is a display employing a parallax barrier system and using a liquid crystal barrier. It is to be noted that a method of driving of a display, a barrier device, and a method of producing of a barrier device according to embodiments of the present disclosure are implemented by the present embodiment and thus will be described together. The stereoscopic display 1 includes a control section 40, a display drive section 50, a display section 20, a backlight drive section 42, a backlight 30, a barrier drive section 41, and a liquid-crystal barrier section 10.

The control section 40 is a circuit that supplies a control signal to each of the display drive section 50, the backlight drive section 42, and the barrier drive section 41, based on an image signal Sdisp supplied externally, thereby controlling these sections to operate in synchronization with one another. Specifically, the control section 40 supplies an image signal S based on the image signal Sdisp to the display drive section 50, supplies a backlight control signal CBL to the backlight drive section 42, and supplies a barrier control signal CBR to the barrier drive section 41. Here, in a case where the stereoscopic display 1 performs stereoscopic vision display, each image signal S includes image signals SA and SB having a plurality of (six in this example) perspective images, as will be described later.

The display drive section 50 drives the display section 20 based on the image signal S supplied from the control section 40. In this example, the display section 20 is a liquid-crystal display section, and performs display by driving a liquid crystal display element and thereby modulating light emitted from the backlight 30.

The backlight drive section 42 drives the backlight 30 based on the backlight control signal CBL supplied from the control section 40. The backlight 30 has a function of emitting light of plane emission to the display section 20. The backlight 30 is configured using LED (Light Emitting Diode), CCFL (Cold Cathode Fluorescent Lamp), or the like.

The barrier drive section 41 generates a barrier drive signal DRV based on the barrier control signal CBR supplied from the control section 40, and supplies the generated signal to the liquid-crystal barrier section 10. The liquid-crystal barrier section 10 allows the light which has been emitted from the backlight 30 and then has passed through the display section 20 to pass therethrough (open operation) or to be blocked (close operation), and has open-close sections 11 and 12 (to be described later) configured using a liquid crystal.

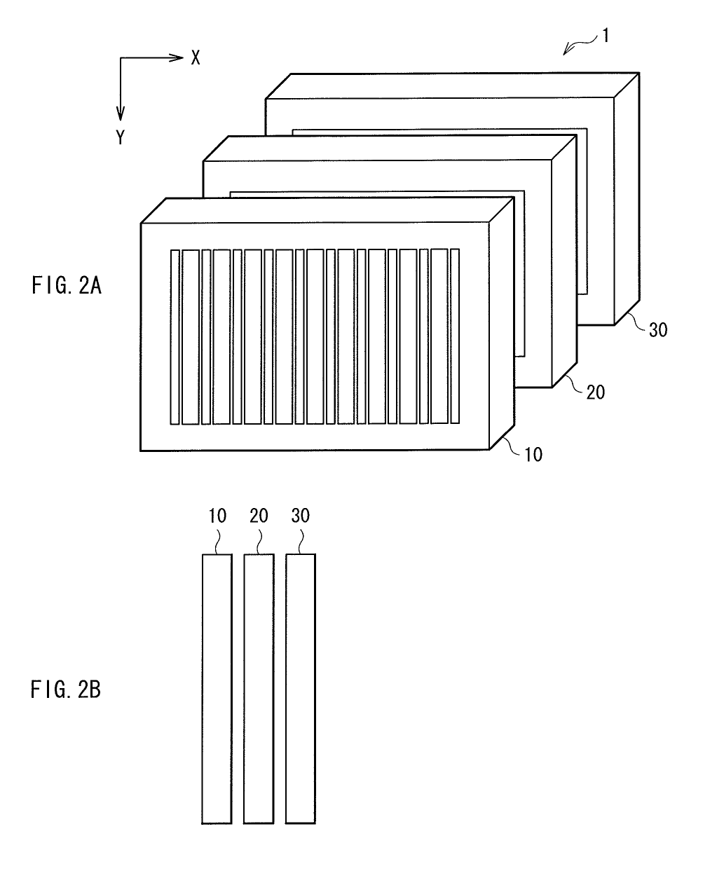

FIGS. 2A and 2B illustrate a configurational example of a main part of the stereoscopic display 1, and illustrate an exploded perspective configuration of the stereoscopic display 1 and a side view of the stereoscopic display 1, respectively. As illustrated in FIGS. 2A and 2B, in the stereoscopic display 1, these components are disposed in order of the backlight 30, the display section 20, and the liquid-crystal barrier section 10. In other words, the light emitted from the backlight 30 reaches a viewer, through the display section 20 and the liquid-crystal barrier section 10.

### (Display Drive Section 50 and Display Section 20)

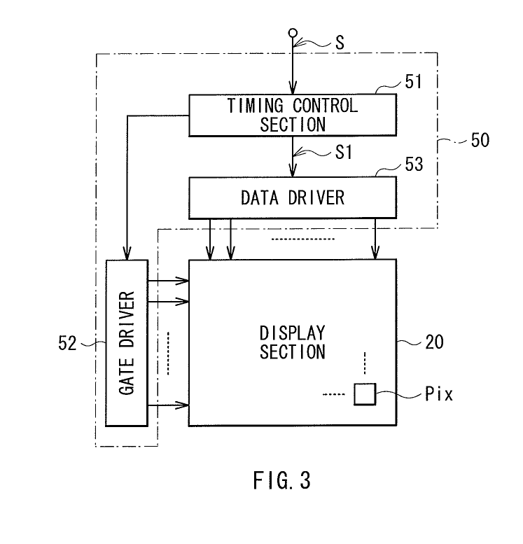

FIG. 3 illustrates an example of a block diagram of the display drive section 50 and the display section 20. The display drive section 50 includes a timing control section 51, a gate driver 52, and a data driver 53. The timing control section 51 controls timing of driving the gate driver 52 and the data driver 53, and supplies the data driver 53 with the image signal S supplied from the control section 40, as an image signal S1. The gate driver 52 selects and sequentially scans pixels Pix in the display section 20 row by row, according to timing control performed by the timing control section 51. The data driver 53 supplies a pixel signal based on the image signal S1 to each of the pixels Pix of the display section 20. Specifically, the data driver 53 generates the pixel signal which is an analog signal, by performing D/A (digital to analog) conversion based on the image signal S1, and supplies the generated pixel signal to each of the pixels Pix.

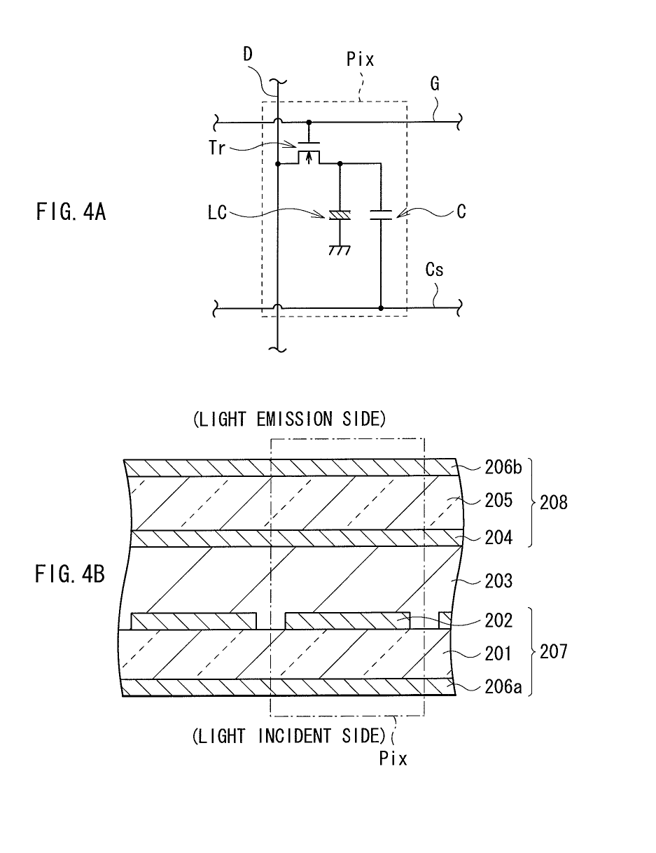

FIGS. 4A and 4B illustrate a configurational example of the display section 20, and illustrate an example of a circuit diagram of the pixel Pix and a cross-sectional configuration of the display section 20, respectively.

The pixel Pix includes a TFT (Thin Film Transistor) element Tr, a liquid crystal element LC, and a retention capacitive element C, as illustrated in FIG. 4A. The TFT element Tr is configured using, for example, a MOS-FET (Metal Oxide Semiconductor-Field Effect Transistor), in which a gate is connected to a gate line G, a sauce is connected to a data line D, and a drain is connected to one end of the liquid crystal element LC and one end of the retention capacitive element C. As for the liquid crystal element LC, one end is connected to the drain of the TFT element Tr, and the other end is grounded. As for the retention capacitive element C, one end is connected to the drain of the TFT element Tr, and the other end is connected to a retention capacitive line Cs. The gate line G is connected to the gate driver 52, and the data line D is connected to the data driver 53.

The display section 20 is formed by sealing a liquid crystal layer 203 between a drive substrate 207 and a counter substrate 208 as illustrated in FIG. 4B. The drive substrate 207 has a transparent substrate 201, pixel electrodes 202, and a polarizing plate 206a. In the transparent substrate 201, a pixel drive circuit (not illustrated) including the TFT element Tr mentioned above is formed, and on this transparent substrate 201, the pixel electrode 202 is disposed for each of the pixels Pix. Further, the polarizing plate 206a is adhered to a surface of the transparent substrate 201, which is opposite to a surface where the pixel electrodes 202 are disposed. The counter substrate 208 has a transparent substrate 205, a counter electrode 204, and a polarizing plate 206b. A color filter and a black matrix not illustrated are formed at the transparent substrate 205, and further, on a surface on the liquid crystal layer 203 side, the counter electrode 204 is disposed as an electrode common to each of the pixels Pix. To a surface of the transparent substrate 205, which is opposite to the surface where the counter electrode 204 is disposed, the polarizing plate 206b is adhered. The polarizing plate 206a and the polarizing plate 206b are adhered to become crossed Nichol or parallel Nichol with respect to each other.

### (Liquid-Crystal Barrier Section 10 and Barrier Drive Section 41)

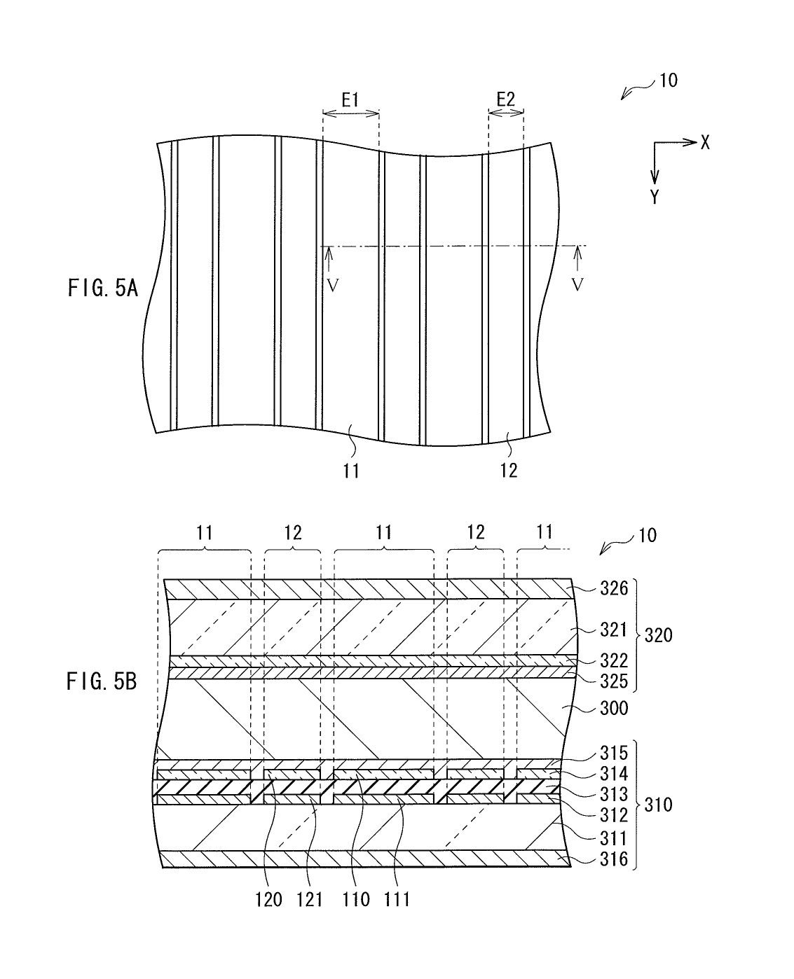

FIGS. 5A and 5B illustrate a configurational example of the liquid-crystal barrier section 10, and illustrate an arrangement configuration of the open-close sections in the liquid-crystal barrier section 10 and a cross-sectional configuration of the liquid-crystal barrier section 10 in a V-V arrow visual direction, respectively. It is to be noted that, in this example, the liquid-crystal barrier section 10 is assumed to perform normally black operation. In other words, the liquid-crystal barrier section 10 is assumed to block the light when being in a non-driven state.

The liquid-crystal barrier section 10 is a so-called parallax barrier, and has the open-close sections (liquid crystal barriers) 11 and 12 allowing the light to pass therethrough or to be blocked as illustrated in FIG. 5A. These open-close sections 11 and 12 operate differently, depending on whether the stereoscopic display 1 performs ordinary display (two-dimensional display) or stereoscopic vision display. Specifically, the open-close section 11 is in an open state (light-transmitting state) at the time of the ordinary display, and is in a closed state (light-blocking state) at the time of the stereoscopic vision display, as will be described later. The open-close section 12 is in an open (light-transmitting state) at the time of the ordinary display, and time-divisionally performs open/close operation at the time of the stereoscopic vision display, as will be described later.

These open-close sections 11 and 12 are, in this example, provided to extend along a Y direction. In this example, a width E1 of the open-close section 11 and a width E2 of the open-close section 12 are different from each other, and here, for example, E1>E2. However, the size relation in terms of width between the open-close sections 11 and 12 is not limited to this example, and may be E1<E2, or may be E1=E2. Such open-close sections 11 and 12 are configured to include a liquid crystal layer (a liquid crystal layer 300 to be described later), and opening and closing are switched by a drive voltage applied to this liquid crystal layer 300.

The liquid-crystal barrier section 10 includes the liquid crystal layer 300 between a drive substrate 310 and a counter substrate 320, as illustrated in FIG. 5B.

The drive substrate 310 includes a transparent substrate 311, a transparent electrode layer 312, an insulating layer 313, a transparent electrode layer 314, an alignment film 315, and a polarizing plate 316. The transparent substrate 311 is made of glass or the like, and a not-illustrated TFT is formed on its surface. Further, the transparent electrode layer 312 is formed thereon via a not-illustrated flattening film. The transparent electrode layer 312 is made of, for example, a transparent conductive film such as ITO (Indium Tin Oxide). On this transparent electrode layer 312, the insulating layer 313 is formed. The insulating layer 313 is made of, for example, SiN. On the insulating layer 313, the transparent electrode layer 314 is formed. The transparent electrode layer 314 is made of, for example, a transparent conductive film such as ITO, like the transparent electrode layer 312. In this transparent electrode layer 314, as will be described later, transparent electrodes 110 and 120 each having a plurality of branch parts 63 are formed. Further, on the transparent electrode layer 314, the alignment film 315 is formed. As the alignment film 315, for example, a vertical alignment agent such as polyimide or polysiloxane may be used. The polarizing plate 316 is adhered to a surface of the drive substrate 310, which is opposite to a surface where the transparent electrode layers 312, 314, and the like are formed.

The counter substrate 320 includes a transparent substrate 321, a transparent electrode layer 322, an alignment film 325, and a polarizing plate 326. Like the transparent substrate 311, the transparent substrate 321 is made of glass or the like. On this transparent substrate 321, the transparent electrode layer 322 is formed. This transparent electrode layer 322 is an electrode formed uniformly over the entire surface, and is made of, for example, a transparent conductive film such as ITO, like the transparent electrode layers 312 and 314. Further, on the transparent electrode layer 322, the alignment film 325 is formed. As the alignment film 325, for example, a vertical alignment agent such as polyimide or polysiloxane may be used, like the alignment film 315. To a surface of the counter substrate 320, which is opposite to a surface where the transparent electrode layer 322 and the like are formed, the polarizing plate 326 is adhered. The polarizing plate 316 and the polarizing plate 326 are adhered to be crossed Nichol with respect to each other. Specifically, for example, a transmission axis of the polarizing plate 316 is arranged in a horizontal direction X, and a transmission axis of the polarizing plate 326 is arranged in a vertical direction Y.

The liquid crystal layer 300 includes, for example, a liquid crystal molecule of a vertical alignment type. This liquid crystal molecule is, for example, in a rotary symmetrical shape in which a major axis and a minor axis each serve as a central axis, and exhibits a negative dielectric anisotropy (a property in which a dielectric constant in a major-axis direction is smaller than that in a minor-axis direction).

The transparent electrode layer 314 has transparent electrodes 110 and 120. Further, the transparent electrode layer 312 has a transparent electrode 111 at a position corresponding to the transparent electrode 110 and a transparent electrode 121 at a position corresponding to the transparent electrode 120. Furthermore, the transparent electrode layer 322 is provided as a so-called common electrode, over a part at a position corresponding to the transparent electrodes 110 and 120, and a common voltage Vcom is applied thereto. In this example, the common voltage Vcom is a DC voltage of 0 V, but is not limited to this example. The transparent electrode 110 of the transparent electrode layer 314, the transparent electrode 111 corresponding to the transparent electrode 110 in the transparent electrode layer 312, and a part corresponding to the transparent electrodes 110 and 111 in the transparent electrode layer 322 are included in the open-close section 11. Similarly, the transparent electrode 120 of the transparent electrode layer 314, the transparent electrode 121 corresponding to the transparent electrode 120 in the transparent electrode layer 312, and a part corresponding to the transparent electrodes 120 and 121 in the transparent electrode layer 322 are included in the open-close section 12. Thanks to such a configuration, in the liquid-crystal barrier section 10, by applying a voltage to the transparent electrode layer 322 and also applying voltages to the transparent electrodes 110 and 111 or the transparent electrodes 120 and 121 selectively, the liquid crystal layer 300 takes a liquid crystal molecular orientation according to that voltage, making it possible to perform the open/close operation for each of the open-close sections 11 and 12.

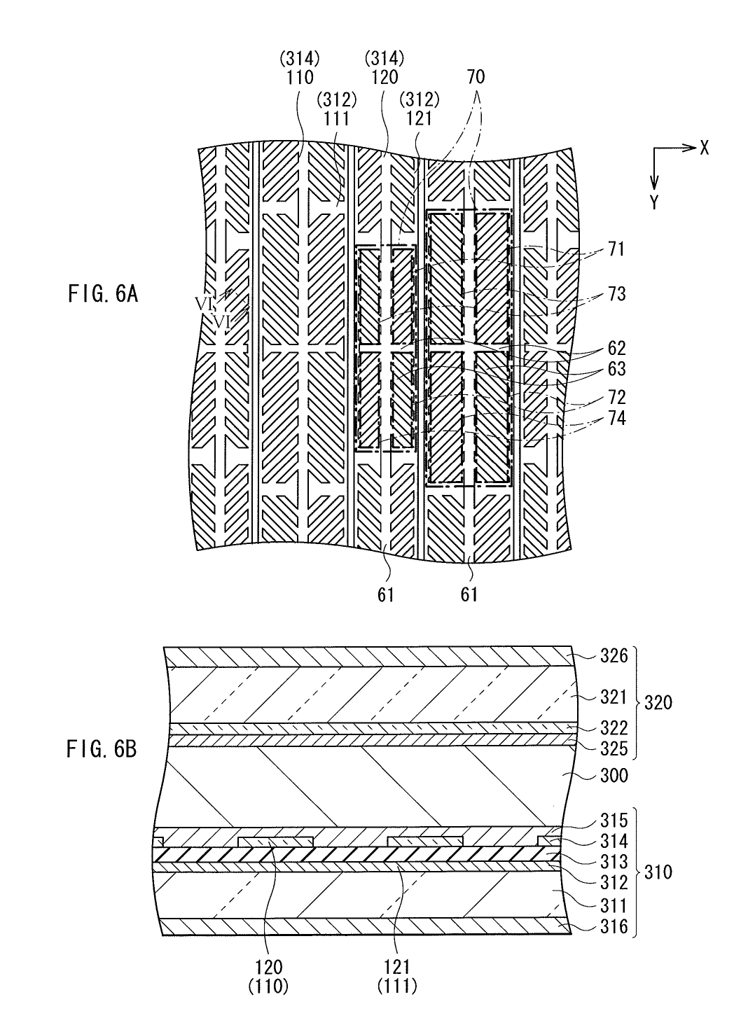

FIGS. 6A and 6B illustrate a configurational example of the transparent electrode layers 312 and 314 in the liquid-crystal barrier section 10. FIG. 6A illustrates a configurational example of the transparent electrodes 111 and 121 in the transparent electrode layer 312 as well as the transparent electrodes 110 and 120 in the transparent electrode layer 314. FIG. 6B illustrates a cross-sectional configuration of the liquid-crystal barrier section 10 in a VI-VI arrow visual direction illustrated in FIG. 6A.

The transparent electrodes 110 and 120 each have a trunk part 61 extending in the same direction as an extending direction of the open-close sections 11 and 12 (a vertical direction Y). Further, in each of the transparent electrodes 110 and 120, a plurality of sub-electrode regions 70 are provided side by side along an extending direction of the trunk part 61. Each of the sub-electrode regions 70 has a trunk part 62 and branch parts 63. The trunk part 62 is formed to extend in a direction intersecting the trunk part 61, and in this example, extend in a horizontal direction X. As for the branch parts 63 provided side by side, a slit is formed between the branch parts 63 adjacent to each other. Each of the sub-electrode regions 70 is provided with four branch regions (domain) 71 to 74 divided by the trunk parts 61 and 62.

The branch parts 63 are formed to extend from the trunk parts 61 and 62 in each of the branch regions 71 to 74. The line widths of the branch parts 63 are equal to one another in the branch regions 71 to 74, and likewise, the distances (slit widths) of the branch parts 63 are also equal to one another in these branch regions 71 to 74. The branch parts 63 of the branch regions 71 to 74 extend in the same direction in each region. An extending direction of the branch parts 63 in the branch region 71 and an extending direction of the branch parts 63 in the branch region 73 are symmetrical with respect to the vertical direction Y serving as an axis. Similarly, an extending direction of the branch parts 63 in the branch region 72 and an extending direction of the branch parts 63 in the branch region 74 are symmetrical with respect to the vertical direction Y serving as an axis. Further, the extending direction of the branch parts 63 in the branch region 71 and the extending direction of the branch parts 63 in the branch region 72 are symmetrical with respect to the horizontal direction X serving as an axis. Similarly, the extending direction of the branch parts 63 in the branch region 73 and the extending direction of the branch parts 63 in the branch region 74 are symmetrical with respect to the horizontal direction X serving as an axis. In this example, specifically, the branch parts 63 of the branch regions 71 and 74 extend in the direction rotated counterclockwise from the horizontal direction X by only a predetermined angle (e.g., 45 degrees), and the branch parts 63 of the branch regions 72 and 73 extend in the direction rotated clockwise from the horizontal direction X by only a predetermined angle (e.g., 45 degrees). The configuration in this way makes it possible to render a viewing angle property when viewed from left and right symmetrical, and also render a viewing angle property when viewed from above and below symmetrical, at the time when a display screen of the stereoscopic display 1 is observed by a viewer.

In the transparent electrode layer 312, the transparent electrode 111 is formed uniformly over a part corresponding to the transparent electrode 110, as illustrated in FIGS. 6A and 6B. In other words, the transparent electrode 111 is formed not only on a part corresponding to the trunk parts 61 and 62 and the branch parts 63 of the transparent electrode 110, but also on a part corresponding to a portion (slit) between the branch parts 63. Similarly, in the transparent electrode layer 312, the transparent electrode 121 is formed uniformly over a part corresponding to the transparent electrode 120, as illustrated in FIGS. 6A and 6B. In other words, the transparent electrode 121 is formed not only on a part corresponding to the trunk parts 61 and 62 and the branch parts 63 of the transparent electrode 120, but also on a part corresponding to a portion (slit) between the branch parts 63 thereof.

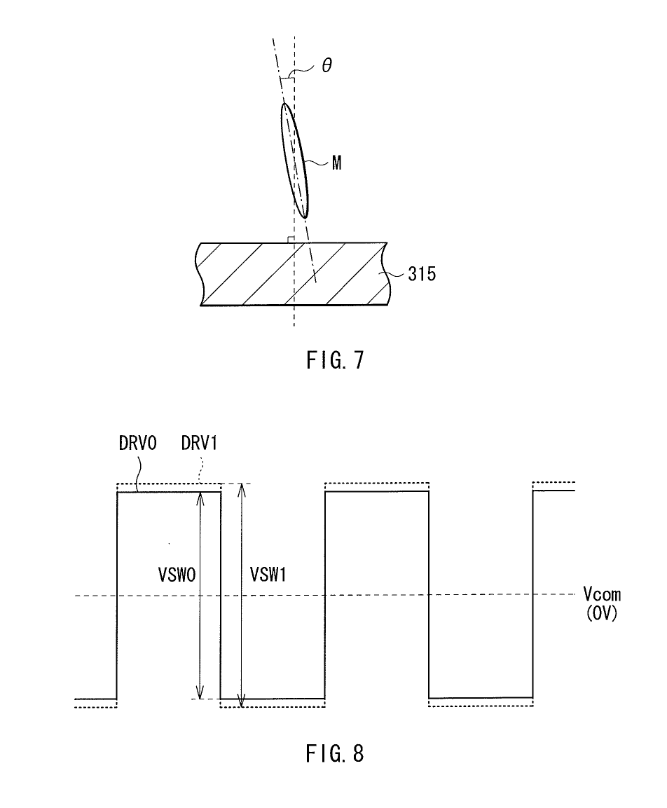

FIG. 7 illustrates alignment of a liquid crystal molecule M when no voltage is applied, in the liquid crystal layer 300. In the liquid crystal layer 300, a major axis direction of the liquid crystal molecule M in proximity to an interface with the alignment films 315 and 325 is maintained in a state of being aligned in a direction approximately vertical with respect to the substrate surface by control from the alignment films 315 and 325, while slightly inclined from that vertical direction. In other words, in proximity to the interface with the alignment films 315 and 325, the liquid crystal layer 300 is given a so-called pretilt. An angle of inclination (a pretilt angle) θ from the vertical direction is, for example, around 3 degrees. Such a pretilt is maintained by a polymer in proximity to the interface with the alignment films 315 and 325 in the liquid crystal layer 300, and other liquid crystal molecules (for example, liquid crystal molecules in the vicinity of a center in a thickness direction of the liquid crystal layer 300) are aligned in a similar direction, following the alignment of this liquid crystal molecule in proximity to the interface.

By this configuration, when a voltage is applied to the transparent electrode layer 314 (the transparent electrodes 110 and 120), the transparent electrode layer 312 (the transparent electrodes 111 and 121), and the transparent electrode layer 322, and thereby a potential difference in voltage between both sides of the liquid crystal layer 300 is made larger, transmittance of light in the liquid crystal layer 300 increases, causing the open-close sections 11 and 12 to change from a light-blocking state (a closed state) to a light-transmitting state (an open state). At the time, by the pretilt described above, the liquid crystal molecule M falls swiftly in response to the application of the voltage, and thereby a change to the light-transmitting state (the open state) occurs quickly. On the other hand, when the potential difference becomes small, the transmittance of the light in the liquid crystal layer 300 decreases, and thereby the open-close sections 11 and 12 enter the light-blocking state (the closed state).

It is to be noted that in this example, the liquid-crystal barrier section 10 performs the normally black operation, but is not limited to this example, and may perform normally white operation instead. In this case, when the potential difference in voltage applied to the liquid crystal layer 300 becomes large, the open-close sections 11 and 12 enter the light-blocking state, whereas when the potential difference becomes small, the open-close sections 11 and 12 enter the light-transmitting state. It is to be noted that, for example, selection between the normally black operation and the normally white operation may be set by adjusting the polarization axis of the polarizing plate.

The barrier drive section 41 generates the barrier drive signal DRV, based on the barrier control signal CBR supplied from the control section 40, and thereby drives the transparent electrodes 110 and 111 (the open-close section 11) and the transparent electrodes 120 and 121 (the open-close section 12) of the liquid-crystal barrier section 10. Specifically, as will be described later, the barrier drive section 41 applies a drive signal DRV0 to the transparent electrode 110, and also applies a drive signal DRV1 to the transparent electrode 111, when driving the open-close section 11. Further, the barrier drive section 41 applies a drive signal DRV0 to the transparent electrode 120, and also applies a drive signal DRV1 to the transparent electrode 121, when driving the open-close section 12. The drive signals DRV0 and DRV1 become DC signals having a common voltage Vcom (0 V) when causing the open-close sections 11 and 12 to perform the close operation (the light-blocking state), and become AC signals when causing the open-close sections 11 and 12 to perform the open operation (the light-transmitting state).

FIG. 8 illustrates an example of each of the drive signals DRV0 and DRV1 when the open-close sections 11 and 12 are caused to perform the open operation (light-transmitting state). When causing the open-close sections 11 and 12 to perform the open operation (light-transmitting state), the drive signals DRV0 and DRV1 each have an alternating waveform with the common voltage Vcom (0 V) in a center. In this example, an amplitude VSW1 of the drive signal DRV1 is set to be greater than an amplitude VSW0 of the drive signal DRV0. For example, the amplitude VSW0 may be 20 V, and the amplitude VSW1 may be 21 V.

In the liquid-crystal barrier section 10, the open-close sections 12 form a group, and the open-close sections 12 belonging to the same group are configured to perform the open operation or the close operation on the same timing, when performing stereoscopic vision display. The group of the open-close sections 12 will be described below.

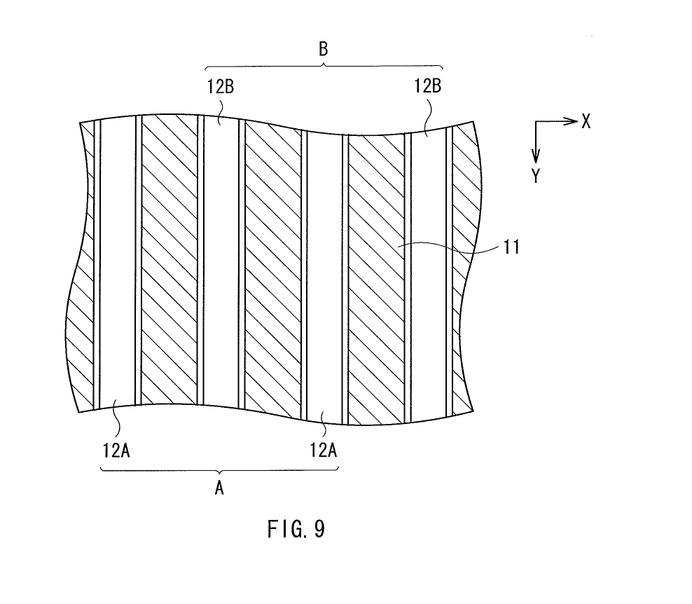

FIG. 9 illustrates an example of a group configuration of the open-close sections 12. The open-close sections 12 form two groups in this example. Specifically, the open-close sections 12 disposed side by side are configured to form a group A and a group B alternately. It is to be noted that, in the following, an open-close section 12A may be used as a generic name for the open-close sections 12 belonging to the group A as appropriate, and likewise, an open-close section 12B may be used as a generic name for the open-close sections 12 belonging to the group B as appropriate.

When the stereoscopic vision display is performed, the barrier drive section 41 carries out driving to make the open-close sections 12 belonging to the same group perform the open/close operation on the same timing. Specifically, as will be described later, the barrier drive section 41 supplies a barrier drive signal DRVA (the drive signals DRV0 and DRV1) to the open-close sections 12A belonging to the group A, and supplies a barrier drive signal DRVB (the drive signals DRV0 and DRV1) to the open-close sections 12B belonging to the group B, thereby performing the driving to cause the open operation and the close operation alternately and time-divisionally.

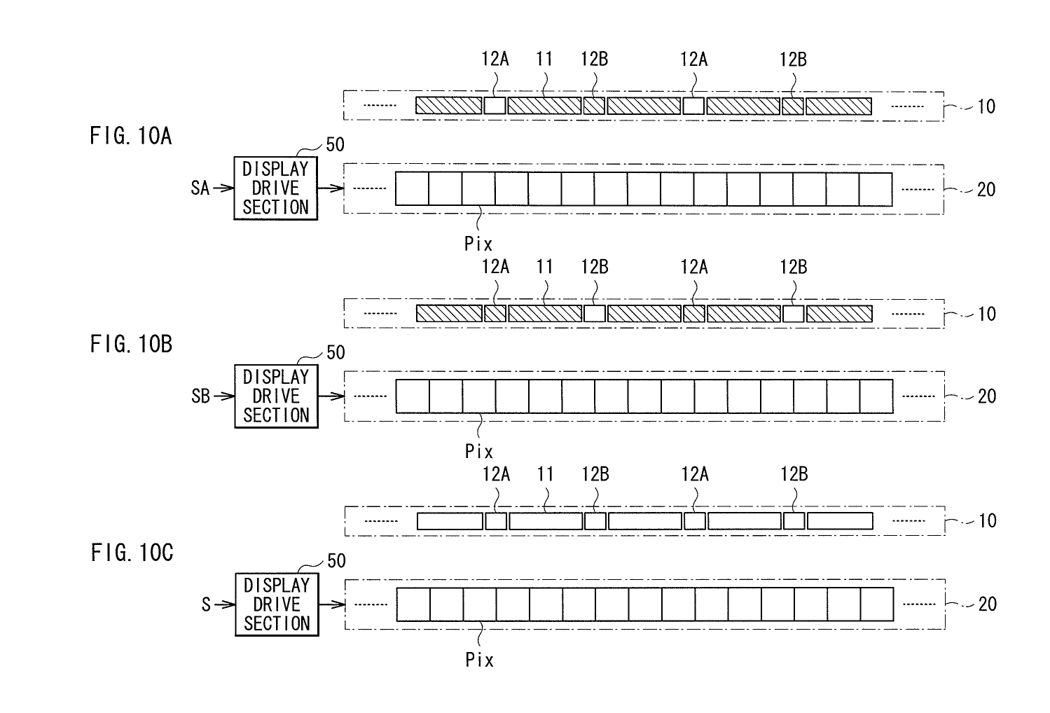

FIGS. 10A to 10C schematically illustrate, using cross-sectional structures, states of the liquid-crystal barrier section 10 when the stereoscopic vision display and the ordinary display (two-dimensional display) are performed. FIG. 10A illustrates the state of performing the stereoscopic vision display, FIG. 10B illustrates another state of performing the stereoscopic vision display, and FIG. 10C illustrates the state of performing the ordinary display. In the liquid-crystal barrier section 10, the open-close sections 11 and the open-close sections 12 (the open-close sections 12A and 12B) are disposed alternately. In this example, one open-close section 12A is provided for every six pixels Pix of the display section 20. Similarly, one open-close section 12B is provided for every six pixels Pix of the display section 20. In the following description, the pixel Pix is assumed to include three subpixels (RGB), but is not limited to this example, and, for instance, the pixel Pix may be a subpixel. Further, in the liquid-crystal barrier section 10, a part where the light is blocked is indicated by a diagonally shaded area.

When the stereoscopic vision display is performed, the image signals SA and SB are supplied to the display drive section 50 alternately, and the display section 20 performs the display based on these signals. Further, in the liquid-crystal barrier section 10, the open-close section 12 (the open-close sections 12A and 12B) time-divisionally perform the open/close operation, and the open-close section 11 maintains the closed state (light-blocking state). Specifically, when the image signal SA is supplied, as illustrated in FIG. 10A, the open-close section 12A enters the open state and the open-close section 12B enters the closed state. In the display section 20, as will be described later, the six pixels Pix adjacent to each other disposed at a position corresponding to this open-close section 12A perform the display corresponding to six perspective images included in the image signal SA. This enables a viewer to feel a displayed image as a stereoscopic image by, for example, watching the perspective images different between the left eye and the right eye. Similarly, when the image signal SB is supplied, as illustrated in FIG. 10B, the open-close section 12B enters the open state and the open-close section 12A enters the closed state. In the display section 20, the six pixels Pix adjacent to each other disposed at a position corresponding to this open-close section 12B perform the display corresponding to six perspective images included in the image signal SB. This enables the viewer to perceive a displayed image as a stereoscopic image by, for example, watching the perspective images different between the left eye and the right eye. In the stereoscopic display 1, the images are thus displayed by alternately opening the open-close section 12A and the open-close section 12B, thereby making it possible to increase resolution of the display as will be described later.

When the ordinary display (two-dimensional display) is performed, in the liquid-crystal barrier section 10, the open-close section 11 and the open-close section 12 (the open-close sections 12A and 12B) both maintain the open state (light-transmitting state) as illustrated in FIG. 10C. This makes it possible for the viewer to view an ordinary two-dimensional image displayed on the display section 20 as-is based on the image signal S.

Here, the open-close sections 11 and 12 correspond to a specific example of “liquid crystal barriers” in the present disclosure. The drive substrate 310 corresponds to a specific example of “a first substrate” in the present disclosure. The counter substrate 320 corresponds to a specific example of “a second substrate” in the present disclosure. The transparent electrode layer 322 corresponds to a specific example of “a common electrode” in the present disclosure. The transparent electrodes 111 and 121 correspond to a specific example of “first electrodes” in the present disclosure. The transparent electrodes 110 and 120 correspond to a specific example of “second electrodes” in the present disclosure. The open-close sections 12 (the open-close sections 12A and 12B) correspond to a specific example of “first liquid crystal barriers” in the present disclosure, and the open-close sections 11 correspond to a specific example of “second liquid crystal barriers” in the present disclosure.

### [Operation and Function]

Next, operation and function of the stereoscopic display 1 of the present embodiment will be described.

### (Summary of Overall Operation)

First, a summary of the overall operation of the stereoscopic display 1 will be described with reference to FIG. 1. Based on the image signal Sdisp supplied externally, the control section 40 supplies a control signal to each of the display drive section 50, the backlight drive section 42, and the barrier drive section 41, thereby controlling these sections to operate in synchronization with one another. The backlight drive section 42 drives the backlight 30 based on the backlight control signal CBL supplied from the control section 40. The backlight 30 emits the light of plane emission to the display section 20. The display drive section 50 drives the display section 20 based on the image signal S supplied from the control section 40. The display section 20 performs display by modulating the light emitted from the backlight 30. The barrier drive section 41 generates the barrier drive signal DRV based on the barrier control signal CBR supplied from the control section 40, and supplies the generated barrier drive signal DRV to the liquid-crystal barrier section 10. The open-close sections 11 and 12 (12A and 12B) of the liquid-crystal barrier section 10 perform the open/close operation based on the barrier control signal CBR, and allow the light which has been emitted from the backlight 30 and then has passed through the display section 20 to pass therethrough or to be blocked.

### (Detailed Operation in Stereoscopic Vision Display)

Next, detailed operation when the stereoscopic vision display is performed will be described with reference to some figures.

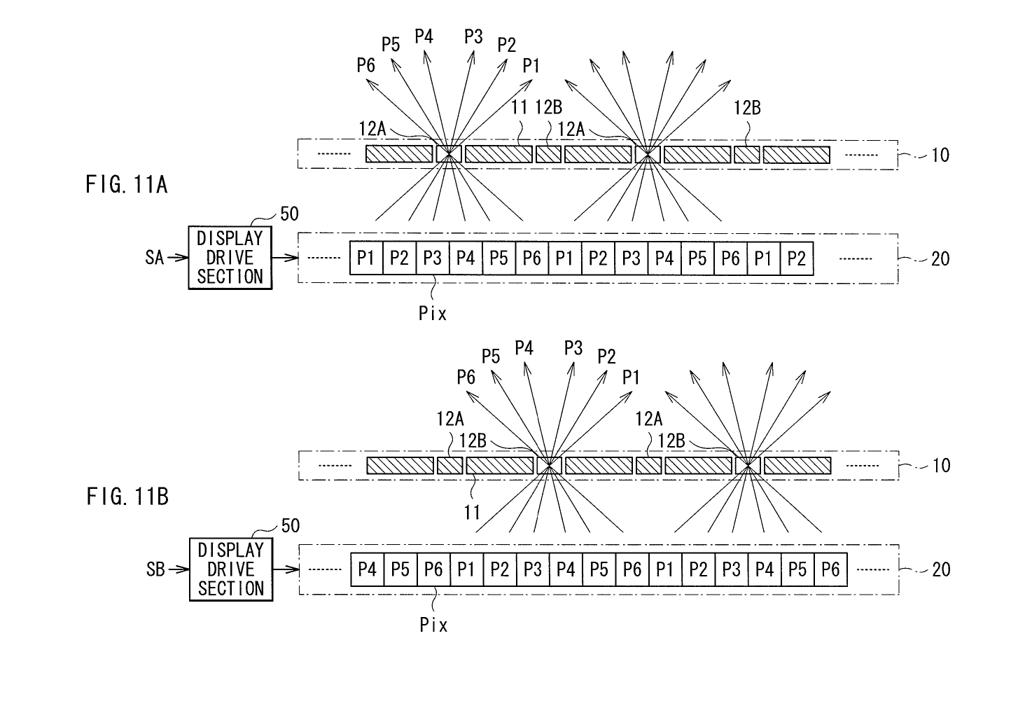

FIGS. 11A and 11B illustrate an example of the operation of the display section 20 and the liquid-crystal barrier section 10. FIG. 11A illustrates a case in which the image signal SA is supplied, and FIG. 11B illustrates a case in which the image signal SB is supplied.

When the image signal SA is supplied, as illustrated in FIG. 11A, the respective pixels Pix of the display section 20 display one of pixel information pieces P1 to P6 corresponding to the respective six perspective images included in the image signal SA. At this moment, the pixel information pieces P1 to P6 are displayed on the pixels Pix disposed in the vicinity of the open-close section 12A. When the image signal SA is supplied, the liquid-crystal barrier section 10 is controlled to have the open-close section 12A in the open state (light-transmitting state) and the open-close section 12B in the closed state. The light leaving from each pixel Pix of the display section 20 is outputted after an angle thereof is limited by the open-close section 12A. The viewer may view a stereoscopic image by, for example, watching the pixel information piece P3 with the left eye and the pixel information piece P4 with the right eye.

When the image signal SB is supplied, the respective pixels Pix of the display section 20 display one of pixel information pieces P1 to P6 corresponding to the six perspective images included in the image signal SB, as illustrated in FIG. 11B. At this moment, the pixel information pieces P1 to P6 are displayed on the respective pixels Pix disposed in the vicinity of the open-close section 12B. When the image signal SB is supplied, the liquid-crystal barrier section 10 is controlled to have the open-close section 12B in the open state (light-transmitting state), and the open-close section 12A in the closed state. The light leaving each pixel Pix of the display section 20 is outputted after an angle thereof is limited by the open-close section 12B. The viewer may view a stereoscopic image by, for example, watching the pixel information piece P3 with the left eye and the pixel information piece P4 with the right eye.

In this way, the viewer watch the pixel information pieces different between the left eye and the right eye among the pixel information pieces P1 to P6, which makes it possible for the viewer to perceive as if watching a stereoscopic image. Further, by opening the open-close section 12A and the open-close section 12B alternately and time-divisionally thereby displaying images, the viewer watches an average image of the images displayed at the positions displaced with respect to each other. Therefore, the stereoscopic display 1 may realize the resolution twice as high as that in the case of having only the open-close section 12A. In other words, the resolution of the stereoscopic display 1 may be one-third (=⅙×2) of the case of the two-dimensional display.

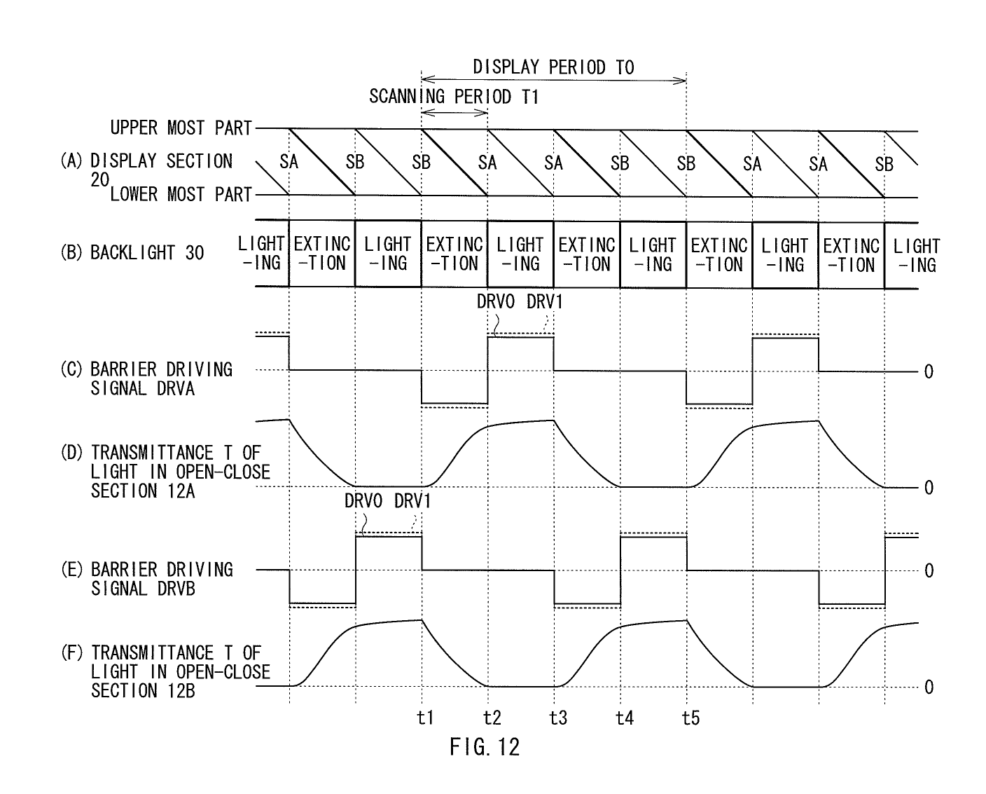

FIG. 12 illustrates a timing chart of the display operation in the stereoscopic display 1, in which Part (A) illustrates operation of the display section 20, Part (B) illustrates operation of the backlight 30, Part (C) illustrates a waveform of the barrier drive signal DRVA, Part (D) illustrates a transmittance T of light in the open-close section 12A, Part (E) illustrates a waveform of the barrier drive signal DRVB, and Part (F) illustrates a transmittance T of light in the open-close section 12B.

A vertical axis in Part (A) of FIG. 12 indicates the position in a line-sequential scanning direction (a Y direction) of the display section 20. In other words, Part (A) of FIG. 12 illustrates an operating state of the display section 20 at a position in the Y direction, at a certain time. In Part (A) of FIG. 12, “SA” indicates a state in which the display section 20 performs display based on the image signal SA, and “SB” indicates a state in which the display section 20 performs display based on the image signal SB.

In the stereoscopic display 1, the display in the open-close section 12A (the display based on the image signal SA) and the display in the open-close section 12B (the display based on the image signal SB) are performed time-divisionally, by line-sequential scanning performed in a scanning period T1. These two kinds of display are repeated every display period T0. Here, for example, the display period T0 may be 16.7 [msec] (corresponding to one period of 60 [Hz]). In this case, the scanning period T1 is 4.2 [msec] (corresponding to a quarter of the display period T0).

The stereoscopic display 1 performs the display based on the image signal SA in a timing period of t2 to t3, and performs the display based on the image signal SB in a timing period of t4 to t5. The details will be described below.

First, in a timing period of t1 to t2, in the display section 20, line-sequential scanning is performed from the uppermost part to the lowermost part based on a drive signal supplied from the display drive section 50, and the display based on the image signal SA is performed (Part (A) of FIG. 12). The barrier drive section 41 applies, as the barrier drive signal DRVA, the drive signal DRV0 to the transparent electrode 120 related to the open-close section 12A, and also applies the drive signal DRV1 to the transparent electrode 121 related to the open-close section 12A (Part (C) of FIG. 12). This increases the transmittance T of the light in the open-close section 12A, in the liquid-crystal barrier section 10 (Part (D) of FIG. 12). In this timing period of t1 to t2, the backlight 30 turns off (Part (B) of FIG. 12). This makes it possible to reduce image deterioration, because the viewer does not view a transient change from the display based on the image signal SB to the display based on the image signal SA, and a transient change in the transmittance T of the light in the open-close section 12, in the display section 20.

Subsequently, in the timing period of t2 to t3, in the display section 20, line-sequential scanning is performed from the uppermost part to the lowermost part based on a drive signal supplied from the display drive section 50, and the display based on the image signal SA is performed again (Part (A) of FIG. 12). At the timing t2, the barrier drive section 41 reverses the voltage of the drive signal DRV0 and then applies this voltage to the transparent electrode 120 related to the open-close section 12A, and also reverses the voltage of the drive signal DRV1 and then applies this voltage to the transparent electrode 121 related to the open-close section 12A. In the liquid-crystal barrier section 10, the transmittance T of the light in the open-close section 12A becomes sufficiently high and thus, the open-close section 12A enters the open state (Part (D) of FIG. 12). The backlight 30 turns on in this timing period of t2 to t3 (Part (B) of FIG. 12). This makes it possible for the viewer to view the display based on the image signal SA of the display section 20, in the timing period of t2 to t3.

Next, in the timing period of t3 to t4, in the display section 20, line-sequential scanning is performed from the uppermost part to the lowermost part based on a drive signal supplied from the display drive section 50, and thereby the display based on the image signal SB is performed (Part (A) of FIG. 12). The barrier drive section 41 applies, as the barrier drive signal DRVA, a DC voltage of 0 V to the transparent electrodes 120 and 121 related to the open-close section 12A, and also applies, as the barrier drive signal DRVB, the drive signal DRV0 to the transparent electrode 120 related to the open-close section 12B and the drive signal DRV1 to the transparent electrode 121 related to the open-close section 12B (Part (E) of FIG. 12). This decreases the transmittance T of the light in the open-close section 12A (Part (D) of FIG. 12), and increases the transmittance T of the light in the open-close section 12B (Part (F) of FIG. 12), in the liquid-crystal barrier section 10. In this timing period of t3 to t4, the backlight 30 turns off (Part (B) of FIG. 12). This makes it possible to reduce image deterioration, because the viewer does not view a transient change from the display based on the image signal SA to the display based on the image signal SB, and a transient change in the transmittance T of the light in the open-close section 12, in the display section 20.

Further, in the timing period of t4 to t5, in the display section 20, line-sequential scanning is performed from the uppermost part to the lowermost part based on a drive signal supplied from the display drive section 50, and thereby the display based on the image signal SB is performed again (Part (A) of FIG. 12). At the timing t4, the barrier drive section 41 reverses the voltage of the drive signal DRV0 and then applies this voltage to the transparent electrode 120 related to the open-close section 12B, and also reverses the voltage of the drive signal DRV1 and then applies this voltage to the transparent electrode 121 related to the open-close section 12B. In the liquid-crystal barrier section 10, the transmittance T of the light in the open-close section 12B becomes sufficiently high, and the open-close section 12B enters the open state (Part (F) of FIG. 12). In this timing period of t4 to t5, the backlight 30 turns on (Part (B) of FIG. 12). This makes it possible for the viewer to view the display based on the image signal SB of the display section 20, in the timing period of t4 to t5.

The stereoscopic display 1 repeats the display based on the image signal SA (the display in the open-close section 12A) and the display based on the image signal SB (the display in the open-close section 12B) alternately, by repeating the above-described operation.

### (Operation of Liquid Crystal Layer 300 of Liquid-Crystal Barrier Section 10)

Next, there will be described operation of the liquid crystal layer 300 to be performed when voltages are applied to the transparent electrode 120 (the transparent electrode layer 314), the transparent electrode 121 (the transparent electrode layer 312), and the transparent electrode layer 322 related to the open-close section 12. It is to be noted that, in the following, the open-close section 12 will be described as an example, but operation is similar in the case of the open-close section 11 (the transparent electrodes 110 and 111, and the transparent electrode layer 322).

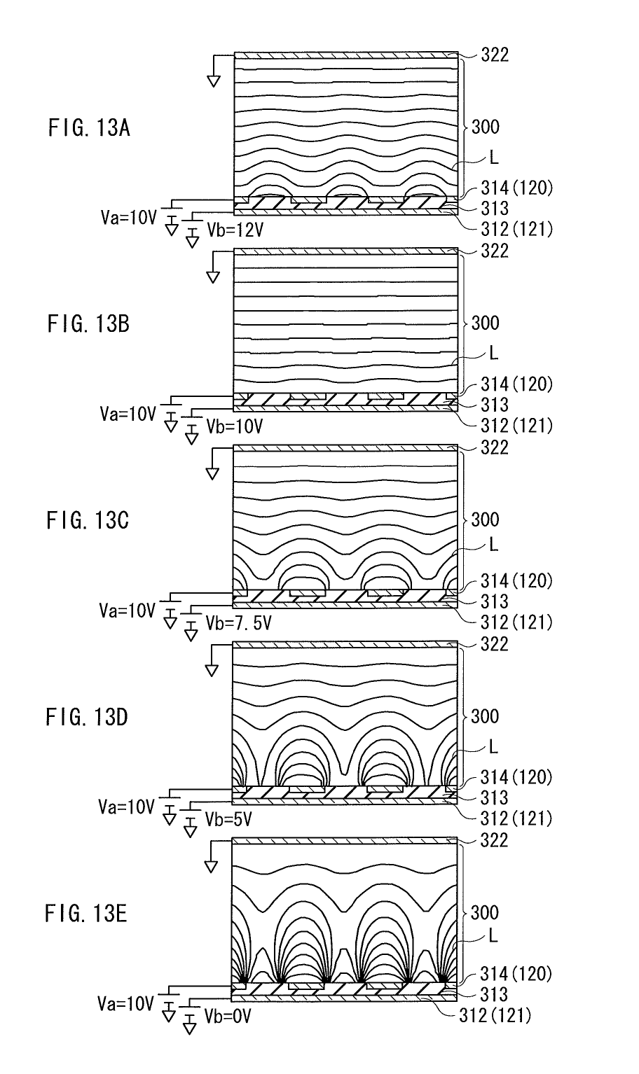

FIGS. 13A to 13E each illustrate an equipotential distribution in the VI-VI arrow direction of FIG. 6A, in the liquid crystal layer 300, when voltages Va and Vb are applied to the transparent electrodes 120 and 121, respectively. It is to be noted that in FIGS. 13A to 13E, for convenience of description, the transparent electrode layers 312 (the transparent electrode 121), 314 (the transparent electrode 120), and 322 are also illustrated. In this example, the voltage Va applied to the transparent electrode 120 is 10 V, and the voltage Vb applied to the transparent electrode 121 is each of 12 V (FIG. 13A), 10 V (FIG. 13B), 7.5 V (FIG. 13C), 5 V (FIG. 13D), and 0 V (FIG. 13A). It is to be noted that in this example, 0 V is applied to the transparent electrode layer 322.

As illustrated in FIGS. 13A to 13E, the equipotential distribution in the liquid crystal layer 300 is changed by the voltage Vb applied to the transparent electrode 121. Specifically, for example, when the voltage Vb is 0 V, the equipotential distribution is formed in the liquid crystal layer 300 so that an equipotential surface L takes the shape of an arc in a region corresponding to a part where each electrode is formed in the transparent electrode layer 314, as illustrated in FIG. 13E. As this voltage Vb increases, the equipotential distribution in the liquid crystal layer 300 becomes flat, as illustrated in FIGS. 13B to 13D. On the other hand, for example, when the voltage Vb is sufficiently higher than the voltage Va (e.g. Vb=12 V), the equipotential distribution is formed in the liquid crystal layer 300 so that the equipotential surface L takes the shape of an arc in a region corresponding to each part where no electrode is formed in the transparent electrode layer 314, as illustrated in FIG. 13A.

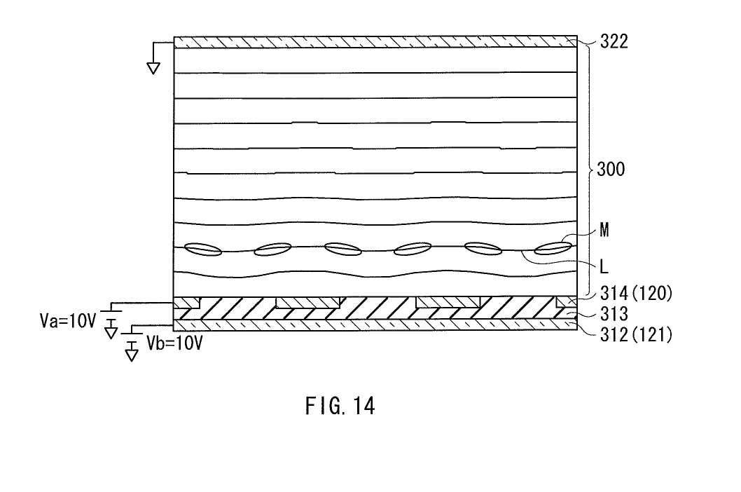

FIG. 14 illustrates alignment of the liquid crystal molecule M of the liquid crystal layer 300 at the time of the open operation (at the time of transmitting operation) of the liquid-crystal barrier section 10. In this example, the voltages Va and Vb are both 10 V, and 0 V is applied to the transparent electrode layer 322. As illustrated in FIG. 14, the liquid crystal molecules M are aligned to have the major axis being parallel to the equipotential surface L. Under this condition, the equipotential distribution becomes approximately flat in the liquid crystal layer 300 and thus, the liquid crystal molecules M in the liquid crystal layer 300 are approximately uniformly aligned so that the major axes are in a direction parallel to the substrate surface.

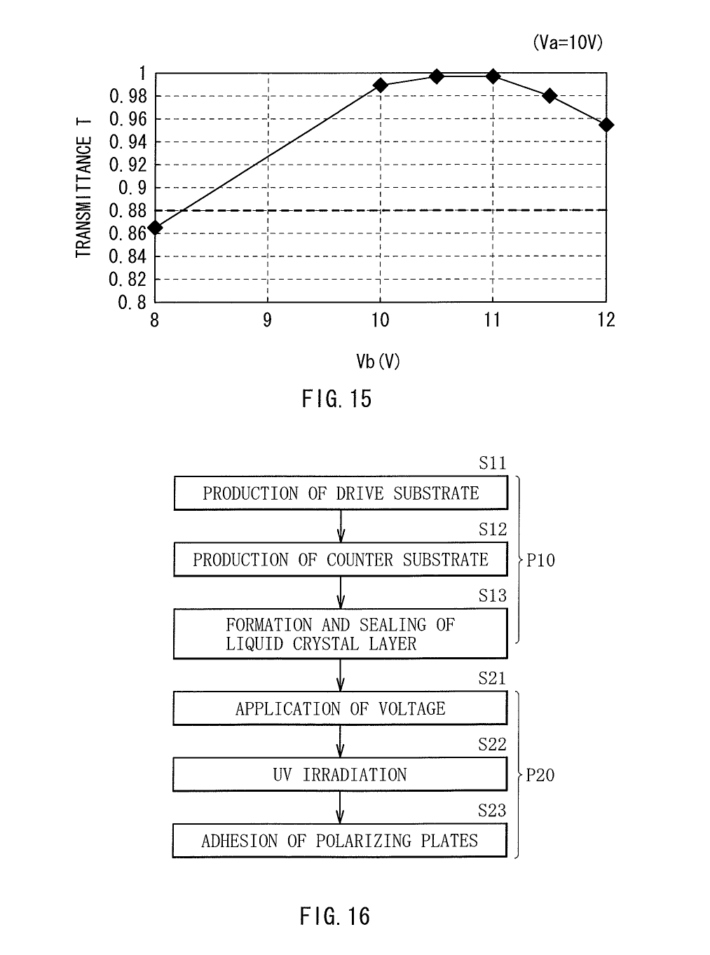

FIG. 15 illustrates the transmittance T of the liquid crystal layer 300 when various voltages Vb are applied to the transparent electrode 121. It is to be noted that the voltage Va is 10 V, and 0 V is applied to the transparent electrode layer 322, as in FIGS. 13A to 13E and FIG. 14.

As the voltage Vb rises from 8 V, the transmittance T of the liquid crystal layer 300 increases as illustrated in FIG. 15. In this example, the transmittance T is the highest when the voltage Vb is around 10.5 V. Subsequently, as the voltage Vb rises further, the transmittance T decreases.

The transmittance T of the liquid crystal layer 300 increases by aligning the liquid crystal molecule M in the direction parallel to the substrate surface. Therefore, this example indicates that the equipotential distribution becomes the flattest when the voltage Vb of around 10.5 V is applied to the transparent electrode 121. The voltage Vb (10.5 V) applied to the transparent electrode 121 for the purpose of flattening the equipotential distribution is thus slightly higher than the voltage Va (10 V) applied to the transparent electrode 120, because of the insulating layer 313. In other words, when 10.5 V is applied to the transparent electrode 121, an electric field is produced in the insulating layer 313 and the liquid crystal layer 300 between the transparent electrode layer 322 of the counter substrate 320 and the transparent electrode 121, through the slit part of the transparent electrode layer 314, and the voltage in the slit part becomes approximately 10 V. As a result, in the transparent electrode layer 314, the part where the transparent electrodes 110 and 120 are provided and the part (slit part) where the electrodes are not provided are approximately equal in terms of voltage, and the voltages applied to the liquid crystal layer 300 become uniform. In this way, it is possible to flatten the equipotential distribution by making the voltage applied to the transparent electrode 121 higher than the voltage applied to the transparent electrode 120 by the amount of the insulating layer 313.

In this way, in the liquid-crystal barrier section 10, the transparent electrode layer 312 is provided, and the voltages are applied to the transparent electrodes 111 and 121 of this transparent electrode layer 312 when the open-close sections 11 and 12 are made to be in the open state (light-transmitting state) and thus, it is possible to flatten the equipotential distribution in the liquid crystal layer 300 and increase the transmittance T.

As described above, when the liquid-crystal barrier section 10 is operated, the transparent electrodes 120 and 121 are driven to flatten the equipotential distribution in the liquid crystal layer 300 (e.g. FIG. 13B), in order to increase the transmittance T of the liquid crystal layer 300. On the other hand, when the liquid-crystal barrier section 10 is produced, the transparent electrodes 120 and 121 are driven to have the equipotential distribution with an electric field distortion (a horizontal electric field) (e.g., FIG. 13C), in order to provide the pretilt. A production process of the liquid-crystal barrier section 10 will be described below.

### (Production Process of Liquid-Crystal Barrier Section 10)

FIG. 16 illustrates the production process of the liquid-crystal barrier section 10. The production process of the liquid-crystal barrier section 10 includes a barrier producing step P10 and a pretilt providing step P20. In the barrier producing step P10, the drive substrate 310 and the counter substrate 320 are produced and then, the liquid crystal layer 300 is formed between the drive substrate 310 and the counter substrate 320 and sealed. In the pretilt providing step, a pretilt is given by applying a voltage to each electrode of the drive substrate 310 and the counter substrate 320, and irradiating the electrode with UV, and lastly, the polarizing plates 316 and 326 are adhered. The details will be described below.

First, in the barrier producing step P10, the drive substrate 310 is produced (step S11). Specifically, at first, the transparent electrode layer 312 is formed on the surface of the transparent substrate 311 by, for example, vapor deposition or sputtering, and then is patterned to be rectangular by a photolithography method, and thereby the transparent electrodes 111 and 121 are formed. Subsequently, on this transparent electrode layer 312, the insulating layer 313 is formed to have a desired thickness by, for example, a plasma CVD method. Next, the transparent electrode layer 314 is formed on the insulating layer 313 by, for example, vapor deposition or sputtering, and then patterned by a photolithography method to form the transparent electrodes 110 and 120 each having the trunk parts 61 and 62 and the branch parts 63. It is to be noted that a contact hall is provided in the insulating layer 313 and a flattening film, and the transparent electrode layers 312 and 314 are each electrically connected via this contact hall to a peripheral wire made of metal or the like formed on the transparent substrate 311. Subsequently, a vertical alignment agent is applied by, for example, spin coating, to cover the surface of the transparent electrode layer 314 and the surface of the insulating layer 313 exposed by a gap (slit) between the transparent electrodes 110 and 120 in the transparent electrode layer 314 and then, the vertical alignment agent is baked to form the alignment film 315.

Next, the counter substrate 320 is produced (step S12). Specifically, first, the transparent electrode layer 322 is formed on the surface of the transparent substrate 321 by, for example, vapor deposition or sputtering. Subsequently, a vertical alignment agent is applied to the surface of this transparent electrode layer 322 by, for example, spin coating, and baked to form the alignment film 325.

Next, the liquid crystal layer is formed and sealed (step S13). Specifically, at first, for example, a UV curable or thermosetting seal section is formed by printing on a peripheral region of the drive substrate 310 produced in step S11. Subsequently, a liquid crystal mixed with, for example, a UV curable monomer is dropped into a region surrounded by this seal section, and thereby the liquid crystal layer 300 is formed. Thereafter, the counter substrate 320 is laid on the drive substrate 310 via a spacer made of, for example, a photosensitive acrylic resin, and the seal section is cured. In this way, the liquid crystal layer 300 is sealed between the drive substrate 310 and the counter substrate 320.

Next, in the pretilt providing step P20, voltages are applied (step S21). Specifically, in the drive substrate 310, the voltage Va (e.g., 10 V) is applied to all the transparent electrodes 110 and 120 of the transparent electrode layer 314, and the voltage Vb (e.g., 7.5 V) lower than the voltage Va is applied to all the transparent electrodes 111 and 121 of the transparent electrode layer 312. Further, in the counter substrate 320, the voltage Vcom (0 V) is applied to the transparent electrode layer 322. This causes an electric field distortion (a horizontal electric field) in the liquid crystal layer 300 as illustrated in FIG. 13C, for example, and the liquid crystal molecules M incline according to the patterns of the branch regions 71 to 74 of the transparent electrodes 110 and 120.

Next, UV is emitted (step S22). Specifically, UV irradiation is performed while applying the voltages as described in step S21.

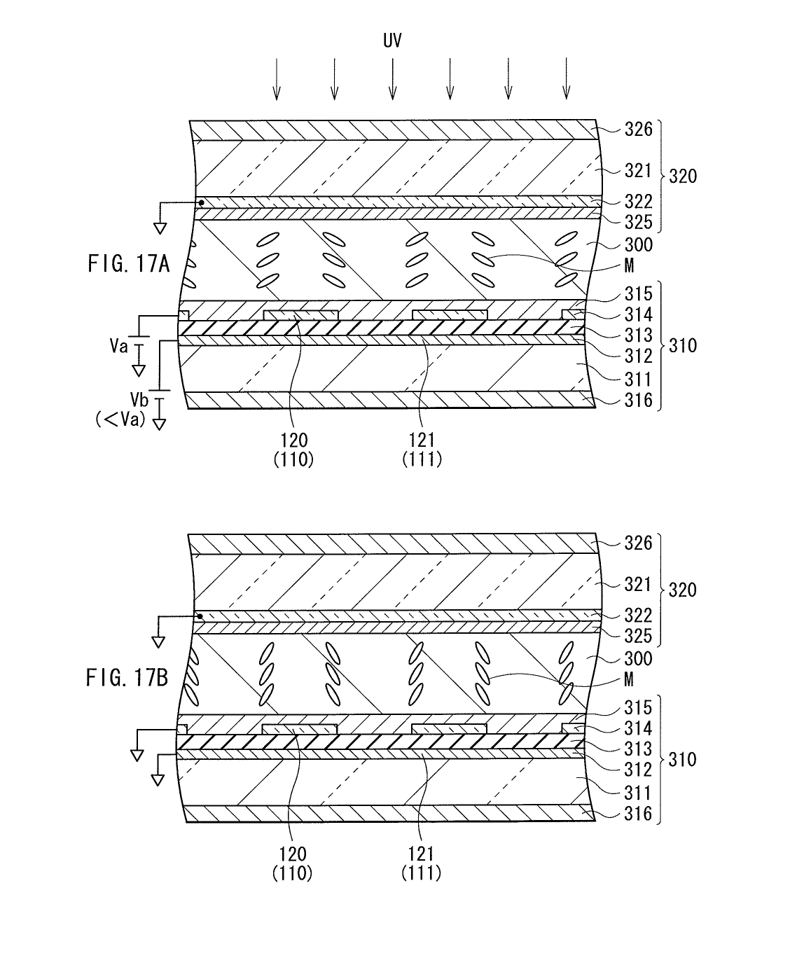

FIGS. 17A and 17B each illustrate a state of the liquid crystal molecules M in the liquid crystal layer 300 when the pretilt is provided, and illustrate the state at the time of the UV irradiation and the state after the UV irradiation, respectively. As illustrated in FIG. 17A, the monomer mixed into the liquid crystal layer 300 is cured in proximity to the interface with the alignment films 315 and 325, by applying the voltage to each of all the transparent electrodes 110 and 120 of the transparent electrode layer 314, all the transparent electrodes 111 and 121 of the transparent electrode layer 312, and the transparent electrode layer 322, and performing the UV irradiation in the state in which the liquid crystal molecules M are inclined. Subsequently, when 0 V is applied to all of these electrodes, the polymer formed in proximity to the interface maintains the liquid crystal molecules M in a state of being inclined slightly from a vertical direction, as illustrated in FIG. 17B. In this way, the liquid crystal molecule M is given a pretilt angle θ.

Next, the polarizing plates are adhered (step S23). Specifically, the polarizing plate 316 is adhered to a surface of the transparent substrate 311 opposite to a surface where the liquid crystal layer 300 is sealed, and the polarizing plate 326 is adhered to a surface of the transparent substrate 321 opposite to a surface where the liquid crystal layer 300 is sealed. At the time, the polarizing plates 316 and 326 are adhered to have the crossed Nichol arrangement with respect to each other, when the liquid crystal barrier performing the normally black operation is produced.

The liquid-crystal barrier section 10 is thus completed.

In this way, in the liquid-crystal barrier section 10, the transparent electrode layer 314 is provided and the voltages are applied to the transparent electrodes 110 and 120 of this transparent electrode layer 314 at the time of producing the liquid-crystal barrier section 10 and thus, the pretilt may be provided.

### COMPARATIVE EXAMPLE

Next, a liquid-crystal barrier section 10R according to a comparative example will be described, and a function of the present embodiment will be described in comparison with the comparative example.

The present comparative example is an example in which in a drive substrate, the liquid-crystal barrier section 10R is configured using a drive substrate 310R which does not include the transparent electrode layer 312. The comparative example is otherwise similar in configuration to the present embodiment (FIG. 1 and the like).

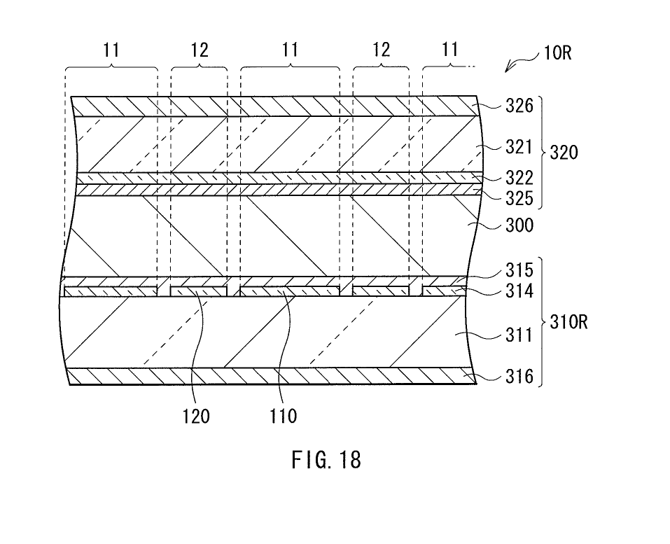

FIG. 18 illustrates a configurational example of the liquid-crystal barrier section 10R according to the present comparative example. The liquid-crystal barrier section 10R has the drive substrate 310R. The drive substrate 310R is formed by eliminating the transparent electrode layer 312 (the transparent electrodes 111 and 121) and the insulating layer 313 in the drive substrate 310 according to the present embodiment.

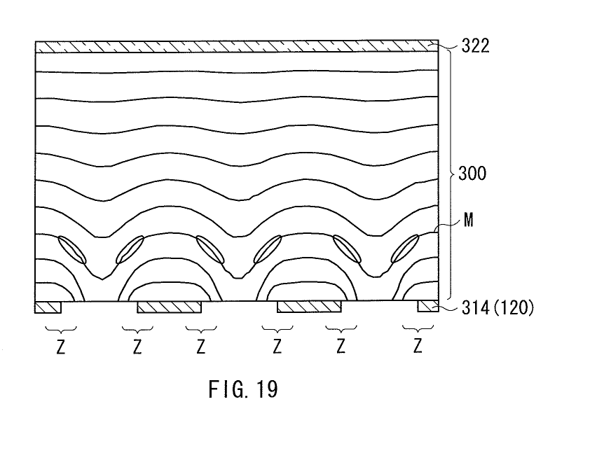

FIG. 19 illustrates alignment of liquid crystal molecules M of the liquid crystal layer 300 at the time of open operation (at the time of transmitting operation) of the liquid-crystal barrier section 10R according to the present comparative example. In the liquid-crystal barrier section 10R according to the present comparative example, unlike the liquid-crystal barrier section 10 according to the present embodiment, the transparent electrode layer 312 is not provided in the drive substrate and thus, it is difficult to make an equipotential distribution uniform in a liquid crystal layer 300 as illustrated in FIG. 19, and an electric field distortion (a horizontal electric field) occurs in a part Z corresponding to each end part of the transparent electrode 120. The liquid crystal molecule M is aligned to make its major axis parallel to an equipotential surface and thus, in this part Z, the liquid crystal molecule M deviates from a direction parallel to a substrate surface, thereby decreasing a transmittance T of the liquid crystal layer 300. Specifically, as indicated by a dotted line in FIG. 15, the transmittance T of the liquid-crystal barrier section 10R according to the present comparative example takes a low value (for example, around 0.88).

On the other hand, in the liquid-crystal barrier section 10 according to the present embodiment, the transparent electrode layer 312 is provided, and the voltages are applied to the transparent electrodes 111 and 121 of the transparent electrode layer 312 when the open-close sections 11 and 12 are caused to enter the open state (light-transmitting state) and thus, it is possible to prevent the electric field distortion (horizontal electric field) from occurring in this part Z, making it possible to suppress a decline in the transmittance T of the liquid crystal layer 300.

### [Effects]

As described above, in the present embodiment, the transparent electrode layer 312 is provided and the voltages are applied to the transparent electrodes 111 and 121 of this transparent electrode layer 312 when the open-close sections are caused to enter the open state (light-transmitting state) and thus, it is possible to apply a sufficient voltage to not only the transparent electrodes 110 and 120 in the transparent electrode layer 314 but also the slit part. Therefore, the equipotential distribution in the liquid crystal layer may be flattened and the transmittance may be increased.

Further, in the present embodiment, the amplitude of the drive signal DRV 1 applied to the transparent electrodes 111 and 121 is made greater than the amplitude of the drive signal DRV0 applied to the transparent electrodes 110 and 120, when the open-close sections are made to enter the open state (light-transmitting state). Therefore, it is possible to further flatten the equipotential distribution in the liquid crystal layer, and increase the transmittance.

Furthermore, in the present embodiment, the transparent electrode layer 314 is provided and arbitrary voltages may be applied to the transparent electrodes 110 and 120 of this transparent electrode layer 314 at the time of producing the liquid-crystal barrier section and therefore, it is possible to stabilize the liquid crystal alignment at the time of providing the pretilt, and improve the response characteristics of the barrier by this pretilt, during the operation.

Moreover, in the present embodiment, an arbitrary voltage may be applied also to the transparent electrode layer 312 at the time of producing the liquid-crystal barrier section and thus, it is possible to adjust the pretilt angle by the application of the voltage.

### [Modification 1]

In the embodiment described above, the transparent electrodes 110 and 120 of the transparent electrode layer 314 each have the four branch regions (domain) 71 to 74, but are not limited to this example. There will be described below a case where these transparent electrodes each have two branch regions, as an example.

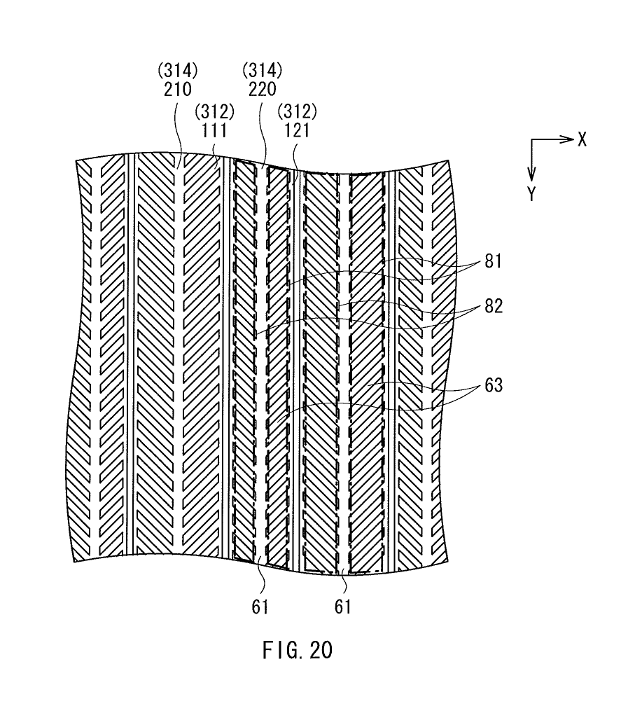

FIG. 20 illustrates a configurational example of transparent electrode layers 312 and 314 in a liquid-crystal barrier section according to the present modification. The transparent electrode layer 314 has a transparent electrode 210 related to an open-close section 11, and a transparent electrode 220 related to an open-close section 12. The transparent electrodes 210 and 220 each have two branch regions 81 and 82 divided by a trunk part 61.

Branch parts 63 are formed to extend from the trunk part 61, in each of the branch regions 81 and 82. The branch parts 63 of the branch regions 81 and 82 extend in the same direction within each region, while extending in directions varying among the branch regions. An extending direction of the branch parts 63 in the branch region 81 and an extending direction of the branch parts 63 in the branch region 82 are symmetrical with respect to a vertical direction Y serving as an axis. In this example, specifically, the branch parts 63 of the branch region 81 extend in a direction rotated counterclockwise from a horizontal direction X by only a predetermined angle (e.g. 45 degrees), and the branch parts 63 of the branch region 82 extend in a direction rotated clockwise from the horizontal direction X by only a predetermined angle (e.g., 45 degrees).

In this case, also, it is possible to flatten an equipotential distribution in a liquid crystal layer 300 and thereby increase a transmittance T, by applying voltages to transparent electrodes 111 and 121 of the transparent electrode layer 312 when causing the open-close sections to enter an open state (light-transmitting state), and also, it is possible to provide a pretilt by applying voltages to the transparent electrodes 210 and 220 of the transparent electrode layer 314 at the time of producing the liquid-crystal barrier section.

### [Modification 2]

In the embodiment described above, when the open-close sections 11 and 12 perform the open/close operation, the drive signal DRV0 is applied to the transparent electrodes 110 and 120 of the transparent electrode layer 314 and the drive signal DRV1 with greater amplitude is applied to the transparent electrodes 111 and 121 of the transparent electrode layer 312. However, this is not a limitation, and instead, drive signals with the same amplitude may be applied to the transparent electrodes 110, 111, 120, and 121. This corresponds to a case in which the voltage Vb is 10 V, in the example of FIG. 15. In this case, for example, compared to the above-described comparative example, it is also possible to sufficiently increase the transmittance T of the liquid crystal layer 300, and simplify the configuration of the barrier drive section 41 generating the barrier drive signal DRV.

### [Modification 3]

In the embodiment described above, the barrier drive section 41 drives both of the transparent electrodes 110 and 120 (the transparent electrode layer 314) and the transparent electrodes 111 and 121 (the transparent electrode layer 312) when operating the liquid-crystal barrier section 10, but is not limited to this example, and may drive only the transparent electrodes 111 and 121 (the transparent electrode layer 312) instead, for example. In this case, for instance, it is possible to make the transparent electrodes 110 and 120 (the transparent electrode layer 314) be in a floating state.

### [Modification 4]

In the embodiment described above, the voltage Vb which is lower than the voltage Va is applied to all the transparent electrodes 111 and 121 of the transparent electrode layer 312 at the time of producing the liquid-crystal barrier section 10, but this is not a limitation, and instead, the voltage Vb equal to the voltage Va (e.g., 10 V) may be applied. In this case, likewise, it is possible to provide a pretilt, because an electric field distortion (a horizontal electric field) occurs as illustrated in FIG. 13B, for example.

### [Modification 5]

In the embodiment described above, the voltages are applied to both of the transparent electrodes 110 and 120 (the transparent electrode layer 314) and the transparent electrodes 111 and 121 (the transparent electrode layer 312) at the time of producing the liquid-crystal barrier section 10, but this is not a limitation, and instead, for example, voltages may be applied only to the transparent electrodes 110 and 120 (the transparent electrode layer 314). In this case, for example, the transparent electrodes 111 and 121 (the transparent electrode layer 312) may be made to be in a floating state.

### [Modification 6]

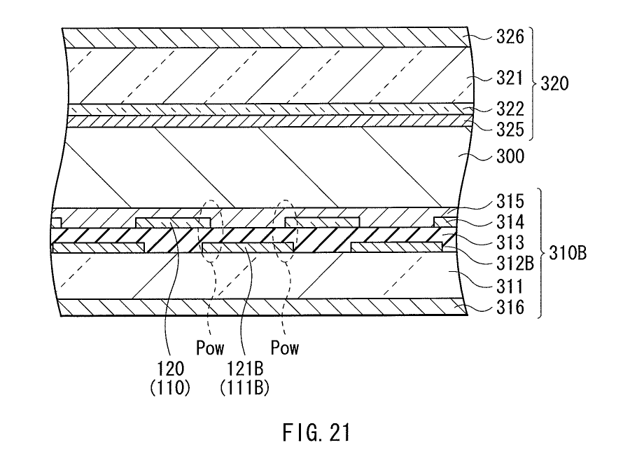

In the embodiment described above, as illustrated in FIG. 6B, for example, in the transparent electrode layer 312, the transparent electrodes 111 and 121 are formed uniformly at the part corresponding to the transparent electrodes 110 and 120, but this is not a limitation. Instead, for example, as illustrated in FIG. 21, transparent electrodes 111B and 121B may be formed at positions corresponding to parts where branch parts 63 are not formed, out of positions corresponding to the transparent electrodes 110 and 120. At the time, it is desirable that the transparent electrodes 110 and 120 and the transparent electrodes 111B and 121B overlap each other as indicated by a part Pow in FIG. 21.

Up to this point, the present technology has been described by using the embodiment and some modifications, but the present technology is not limited to these embodiment and the like, and may be variously modified.

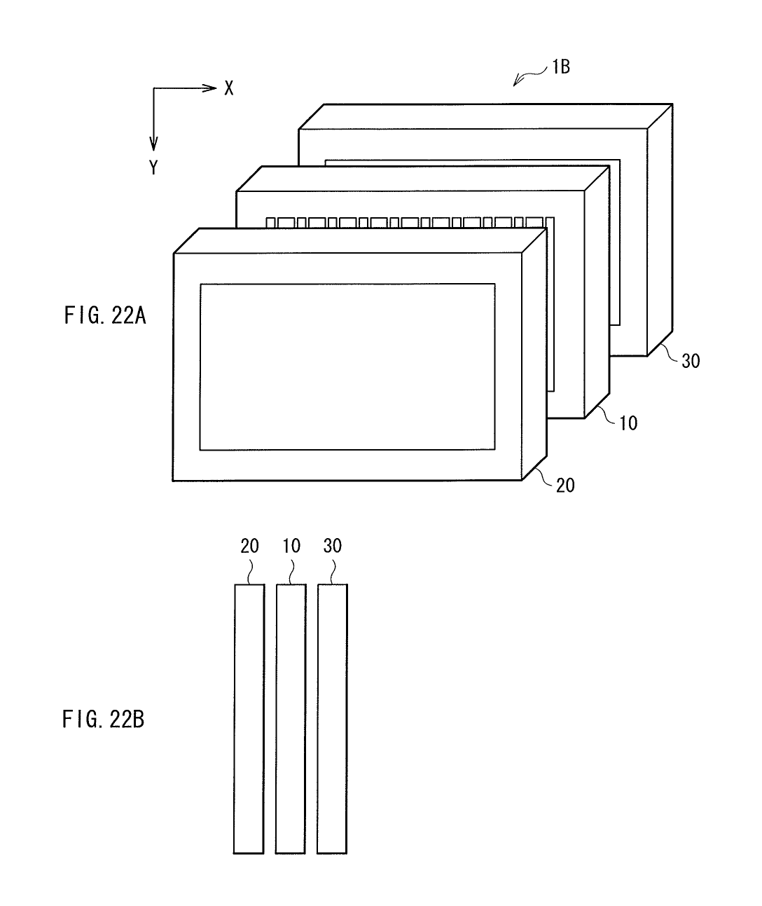

For example, in the embodiment and the like described above, the backlight 30, the display section 20, and the liquid-crystal barrier section 10 of the stereoscopic display 1 are arranged in this order, but this is not a limitation. Instead, the backlight 30, the liquid-crystal barrier section 10, and the display section 20 may be arranged in this order, as illustrated in FIGS. 22A and 22B.

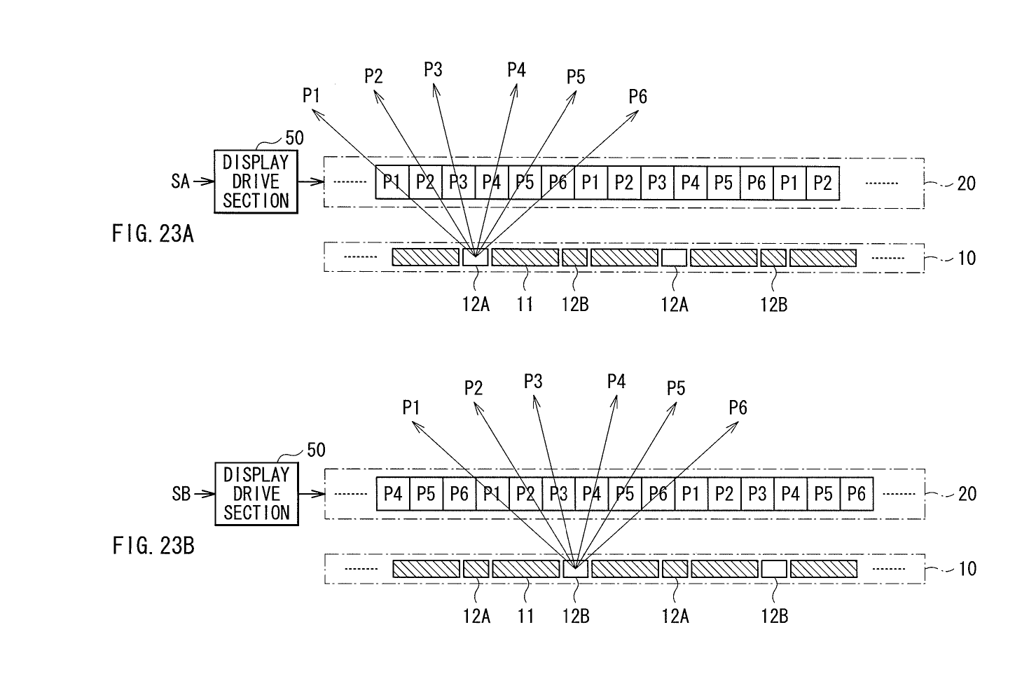

FIGS. 23A and 23B illustrate an example of operation of the display section 20 and the liquid-crystal barrier section 10 according to the present modification, and illustrate a case where an image signal SA is supplied and a case where an image signal SB is supplied, respectively. In the present modification, light emitted from the backlight 30 first enters the liquid-crystal barrier section 10. Of the light, light passing through the open-close sections 12A and 12B is modulated in the display section 20, and six perspective images are outputted.

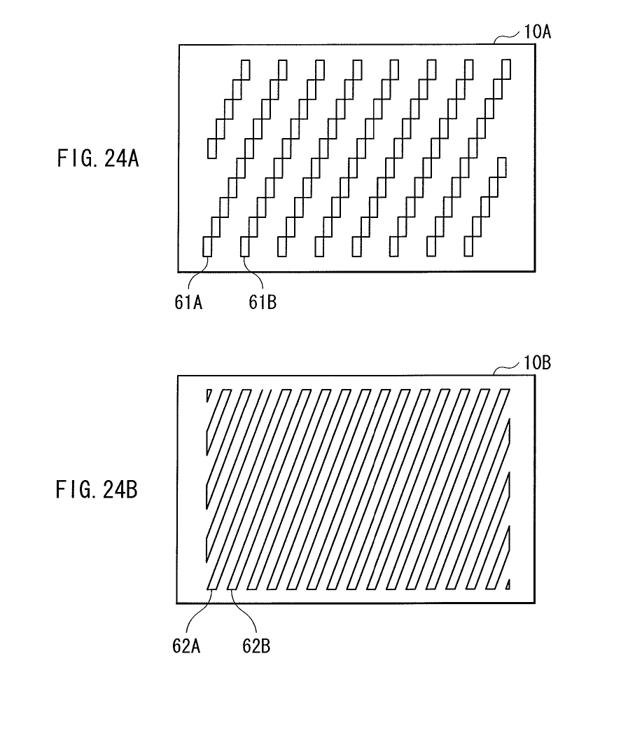

Further, in the embodiment and the like described above, the open-close sections of the liquid crystal barrier extend in the Y-axis direction, but are not limited to this example, and instead, may be, for example, of a step barrier type illustrated in FIG. 24A or a diagonal barrier type illustrated in FIG. 24B. The step barrier type is described in, for example, Japanese Unexamined Patent Application Publication No. 2004-264762. Further, the diagonal barrier type is described in, for example, Japanese Unexamined Patent Application Publication No. 2005-86506.

Furthermore, in the embodiment and the like described above, the open-close sections 12 form the two groups, but are not limited to this example, and instead, may form three or more groups, for example. This makes it possible to further improve the resolution of display. The details will be described below.

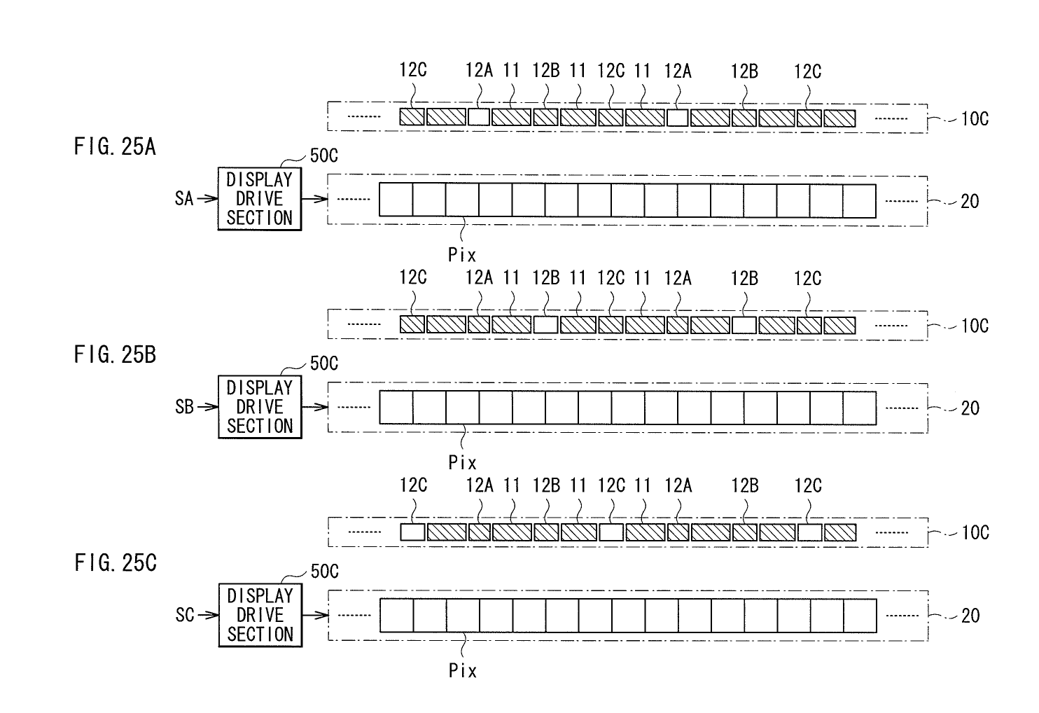

FIGS. 25A to 25C illustrate an example when open-close sections 12 form three groups A, B, and C. Like the embodiment described above, an open-close section 12A indicates the open-close section 12 belonging to the group A, and an open-close section 12B indicates the open-close section 12 belonging to the group B, and further, an open-close section 12C indicates the open-close section 12 belonging to the group C.

Opening the open-close sections 12A, 12B, and 12C time-divisionally and alternately and thereby displaying an image makes it possible for a stereoscopic display according to the present modification to realize resolution three times as high as in a case where only the open-close section 12A is provided. In other words, the resolution of this stereoscopic display may be half (=⅙×3) the case of two-dimensional display.

In addition, for example, in the embodiment and the like described above, the image signals SA and SB each include six perspective images, but are not limited to this example, and may include five or less perspective images or seven or more perspective images. In this case, the relation between the open-close sections 12A and 12B of the liquid-crystal barrier section 10 illustrated in FIGS. 10A to 10C and the pixels Pix also changes. In other words, for example, when the image signals SA and SB include five perspective images, it is desirable to provide one open-close section 12A for every five pixels Pix of the display section 20, and similarly, it is desirable to provide one open-close section 12B for every five pixels Pix of the display section 20.

Moreover, for example, in the embodiment and the like described above, the display section 20 is a liquid crystal display section, but is not limited to this example, and may be, for example, an EL (Electro Luminescence) display section using organic EL. In this case, the backlight drive section 42 and the backlight 30 illustrated in FIG. 1 may not be provided.

It is to be noted that the present technology may be configured as follows.

(1) A display including:

a display section displaying an image; and

a liquid-crystal barrier section having a plurality of liquid crystal barriers each allowed to switch between a light-transmitting state and a light-blocking state,

wherein the liquid-crystal barrier section includes
a liquid crystal layer, and
a first substrate and a second substrate configured to sandwich the liquid crystal layer, the second substrate having a common electrode formed on a first-substrate side thereof, and the first substrate including
a first electrode formed at a position corresponding to each of the liquid crystal barriers, and
a second electrode formed, between the first electrode and the liquid crystal layer, at the position corresponding to each of the liquid crystal barriers.

(2) The display according to the above (1), further including a drive section driving each of the liquid crystal barriers in the liquid-crystal barrier section,

wherein the drive section drives the first electrode or both the first electrode and the second electrode.

(3) The display according to the above (2), wherein the drive section also drives the second electrode.

(4) The display according to any one of the above (1) to (3), wherein the second electrode has a plurality of slits.

(5) The display according to the above (4), wherein

the liquid crystal barrier is formed to extend in a predetermined direction, and

the second electrode includes a trunk part and a plurality of branch parts, the trunk part extending in the predetermined direction, the plurality of branch parts being formed on both sides of the trunk part to form the plurality of slits.

(6) The display according to any one of the above (1) to (5), further including an insulating layer disposed between the first electrode and the second electrode.

(7) The display according to any one of the above (1) to (6), further including a plurality of display modes including a three-dimensional image display mode and a two-dimensional image display mode,

wherein the plurality of liquid crystal barriers include a plurality of first liquid crystal barriers and a plurality of second liquid crystal barriers,

the three-dimensional image display mode allows the display section to display a plurality of different perspective images, allows the plurality of first liquid crystal barriers to be in a light-transmitting state while allowing the plurality of second liquid crystal barriers to be in the light-blocking state, and thus allows a three-dimensional image to be displayed, and

the two-dimensional image display mode allows the display section to display one perspective image, allows both the plurality of first liquid crystal barriers and the plurality of second liquid crystal barriers to be in the light-transmitting state, and thus allows a two-dimensional image to be displayed.

(8) The display according to the above (7), wherein

the plurality of first liquid crystal barriers are grouped into a plurality of barrier groups, and

the three-dimensional image display mode allows the plurality of first liquid crystal barriers to be time-divisionally switched between the light-transmitting state and the light-blocking state for each of the barrier groups.

(9) The display according to any one of the above (1) to (8), further including a backlight,

wherein the display section is a liquid-crystal display section which is disposed between the backlight and the liquid-crystal barrier section.

(10) The display according to any one of the above (1) to (8), further including a backlight,

wherein the display section is a liquid-crystal display section which is disposed between the backlight and the liquid-crystal display section.

(11) A display including:

a display section; and

a liquid-crystal barrier section including a plurality of liquid crystal barriers,

wherein the liquid-crystal barrier section includes

a liquid crystal layer including liquid crystal molecules maintained in a state of being inclined from a vertical direction, and

a first substrate and a second substrate that are configured to sandwich the liquid crystal layer, the second substrate having a common electrode formed on a side facing the first substrate, and the first substrate including
a first electrode formed at a position corresponding to each of the liquid crystal barriers, and
a second electrode formed between the first electrode and the liquid crystal layer, at the position corresponding to each of the liquid crystal barriers.

(12) A display including:

a display section; and

a barrier section,

wherein the barrier section includes liquid crystal molecules maintained in a state of being inclined from a vertical direction.

(13) A method of driving a display, the method including:

driving a plurality of liquid crystal barriers each allowed to switch between a light-transmitting state and a light-blocking state;

displaying an image in synchronization with driving of the liquid crystal barriers;

wherein the driving of the liquid crystal barrier includes:

applying a drive signal to a first electrode or both the first electrode and a second electrode, the first electrode being formed at a position corresponding to each of the liquid crystal barriers, and the second electrode being formed at the position corresponding to each of the liquid crystal barriers, in a layer different from the first electrode; and

applying a common signal to a common electrode, the common electrode being disposed on an opposite side of the second electrode from the first electrode and being opposed to and apart from the second electrode with the liquid crystal layer in between.

(14) The method according to the above (13), wherein the applying of drive signals includes:

applying a first drive signal to the first electrode; and

applying a second drive signal to the second electrode.

(15) The method according to the above (14), wherein

the common signal is a DC signal, and

each of the first drive signal and the second drive signal is a AC drive signal having a center voltage level equal to a DC voltage level of the common signal, the first drive signal having an amplitude different from that of the second drive signal.

(16) The method according to the above (15), wherein the amplitude of the first drive signal is greater than the amplitude of the second drive signal.

(17) The method according to the above (14), wherein

the common signal is a DC signal, and

each of the first drive signal and the second drive signal is a AC drive signal having a center voltage level equal to a DC voltage level of the common signal, the first drive signal having an amplitude equal to that of the second drive signal.

(18) The method according to the above (13), wherein

the common signal is a DC signal, and

the drive signal applied to the first electrode is an AC drive signal having a center voltage level equal to a DC voltage level of the common signal.

(19) A barrier device including:

a liquid crystal layer; and

a first substrate and a second substrate configured to sandwich the liquid crystal layer, the second substrate having a common electrode formed on a first-substrate side thereof, and the first substrate including

a plurality of first electrodes, and

second electrodes each formed between the first electrode and the liquid crystal layer, at the position corresponding to each of the first electrodes.

(20) A method of producing a barrier device, the method including:

forming a plurality of first electrodes on a first substrate, and forming a second electrode over and apart from each of the first electrodes, at a position corresponding to each of the first electrodes;

forming a common electrode on a second substrate;

sealing a liquid crystal layer between a surface of the first substrate and the second substrate, the surface being on a side where the first and second electrodes are formed; and

providing a pretilt to the liquid crystal layer, by exposing the liquid crystal layer, while applying a voltage to the liquid crystal layer through at least the second electrode and the common electrode.

(21) The method according to the above (20), wherein the providing of the pretilt to the liquid crystal layer includes applying a voltage to the first electrode as well.

(22) The method according to the above (21), wherein voltages are applied to the first and second electrodes to allow a potential difference between the first electrode and the common electrode to be smaller than a potential difference between the second electrode and the common electrode.

(23) The method according to the above (21), wherein a voltage applied to the first electrode is equal to a voltage applied to the second electrode.

The present disclosure contains subject matter related to that disclosed in Japanese Priority Patent Application JP 2011-49524 filed in the Japan Patent Office on Mar. 7, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display comprising:
a display section displaying an image; and
a liquid-crystal barrier section having a plurality of liquid crystal barriers each allowed to switch between a light-transmitting state and a light-blocking state,
wherein the liquid-crystal barrier section includes
a liquid crystal layer, and
a first substrate and a second substrate configured to sandwich the liquid crystal layer, the second substrate having a common electrode formed on a first-substrate side thereof, and the first substrate including
a first electrode formed at a position corresponding to each of the liquid crystal barriers, and
a second electrode formed, between the first electrode and the liquid crystal layer, at the position corresponding to each of the liquid crystal barriers.

2. The display according to claim 1, further comprising a drive section driving each of the liquid crystal barriers in the liquid-crystal barrier section,
wherein the drive section drives the first electrode or both the first electrode and the second electrode.

3. The display according to claim 2, wherein the drive section also drives the second electrode.

4. The display according to claim 1, wherein the second electrode has a plurality of slits.

5. The display according to claim 4, wherein the liquid crystal barrier is formed to extend in a predetermined direction, and
the second electrode includes a trunk part and a plurality of branch parts, the trunk part extending in the predetermined direction, the plurality of branch parts being formed on both sides of the trunk part to form the plurality of slits.

6. The display according to claim 1, further comprising an insulating layer disposed between the first electrode and the second electrode.

7. The display according to claim 1, further comprising a plurality of display modes including a three-dimensional image display mode and a two-dimensional image display mode,
wherein the plurality of liquid crystal barriers include a plurality of first liquid crystal barriers and a plurality of second liquid crystal barriers,
the three-dimensional image display mode allows the display section to display a plurality of different perspective images, allows the plurality of first liquid crystal barriers to be in the light-transmitting state while allowing the plurality of second liquid crystal barriers to be in the light-blocking state, and thus allows a three-dimensional image to be displayed, and
the two-dimensional image display mode, allows the display section to display one perspective image, allows both the plurality of first liquid crystal barriers and the plurality of second liquid crystal barriers to be in the light-transmitting state, and thus allows a two-dimensional image to be displayed.

8. The display according to claim 7, wherein
the plurality of first liquid crystal barriers are grouped into a plurality of barrier groups, and
the three-dimensional image display mode allows the plurality of first liquid crystal barriers to be time-divisionally switched between the light-transmitting state and the light-blocking state for each of the barrier groups.

9. The display according to claim 1, further comprising a backlight,
wherein the display section is a liquid-crystal display section which is disposed between the backlight and the liquid-crystal barrier section.

10. The display according to claim 1, further comprising a backlight,
wherein the display section is a liquid-crystal display section which is disposed between the backlight and the liquid-crystal display section.

11. A display comprising:
a display section; and
a liquid-crystal barrier section including a plurality of liquid crystal barriers,
wherein the liquid-crystal barrier section includes
a liquid crystal layer including liquid crystal molecules maintained in a state of being inclined from a vertical direction, and
a first substrate and a second substrate that are configured to sandwich the liquid crystal layer, the second substrate having a common electrode formed on a side facing the first substrate, and the first substrate including
a first electrode formed at a position corresponding to each of the liquid crystal barriers, and
a second electrode formed between the first electrode and the liquid crystal layer, at the position corresponding to each of the liquid crystal barriers.

12. A display comprising:
a display section; and
a barrier section,
wherein the barrier section includes liquid crystal molecules maintained in a state of being inclined from a vertical direction.

13. A method of driving a display, the method comprising:
driving a plurality of liquid crystal barriers each allowed to switch between a light-transmitting state and a light-blocking state; and
displaying an image in synchronization with driving of the liquid crystal barriers,
wherein the driving of the liquid crystal barrier includes:
applying a drive signal to a first electrode or both the first electrode and a second electrode, the first electrode being formed at a position corresponding to each of the liquid crystal barriers, and the second electrode being formed at the position corresponding to each of the liquid crystal barriers, in a layer different from the first electrode; and
applying a common signal to a common electrode, the common electrode being disposed on an opposite side of the second electrode from the first electrode and being opposed to and apart from the second electrode with the liquid crystal layer in between.

14. The method according to claim 13, wherein the applying of drive signals includes:
applying a first drive signal to the first electrode; and
applying a second drive signal to the second electrode.

15. The method according to claim 14, wherein
the common signal is a DC signal, and
each of the first drive signal and the second drive signal is a AC drive signal having a center voltage level equal to a DC voltage level of the common signal, the first drive signal having an amplitude different from that of the second drive signal.

16. The method according to claim 15, wherein the amplitude of the first drive signal is greater than the amplitude of the second drive signal.

17. The method according to claim 14, wherein
the common signal is a DC signal, and
each of the first drive signal and the second drive signal is a AC drive signal having a center voltage level equal to a DC voltage level of the common signal, the first drive signal having an amplitude equal to that of the second drive signal.

18. The method according to claim 13, wherein
the common signal is a DC signal, and
the drive signal applied to the first electrode is an AC drive signal having a center voltage level equal to a DC voltage level of the common signal.

19. A barrier device comprising:
a liquid crystal layer; and
a first substrate and a second substrate configured to sandwich the liquid crystal layer, the second substrate having a common electrode formed on a first-substrate side thereof, and the first substrate including
a plurality of first electrodes, and
second electrodes each formed between the first electrode and the liquid crystal layer, at the position corresponding to each of the first electrodes.

20. A method of producing a barrier device, the method comprising:
forming a plurality of first electrodes on a first substrate, and forming a second electrode over and apart from each of the first electrodes, at a position corresponding to each of the first electrodes;
forming a common electrode on a second substrate;
sealing a liquid crystal layer between a surface of the first substrate and the second substrate, the surface being on a side where the first and second electrodes are formed; and
providing a pretilt to the liquid crystal layer, by exposing the liquid crystal layer, while applying a voltage to the liquid crystal layer through at least the second electrode and the common electrode.

21. The method according to claim 20, wherein the providing of the pretilt to the liquid crystal layer includes applying a voltage to the first electrode as well.

22. The method according to claim 21, wherein voltages are applied to the first and second electrodes to allow a potential difference between the first electrode and the common electrode to be smaller than a potential difference between the second electrode and the common electrode.

23. The method according to claim 21, wherein a voltage applied to the first electrode is equal to a voltage applied to the second electrode.
